(19) United States
(12) Patent Application Publication
(10) Pub. No.: US 2026/0322132 A1
(43) Pub. Date: Oct. 15, 2026

(54) LOW-EMISSION POWER GENERATION SYSTEM AND METHOD

(71) Applicant: Laozi Advisors LLC, New York, NY (US)

(72) Inventors: Glenn William Brown, JR., New York, NY (US); David Menacher, Cupertino, CA (US)

(73) Assignee: Laozi Advisors LLC, New York, NY (US)

(21) Appl. No.: 19/535,991

(22) Filed: Feb. 10, 2026

Related U.S. Application Data
(60) Provisional application No. 63/756,530, filed on Feb. 10, 2025.

(51) Int. Cl. H02J 3/38

(52) U.S. Cl. CPC H02J 3/381

(57) ABSTRACT

A low-emission power generation system comprising: a power source in communication with a power generator; the power generator in communication with a power application and a power grid; and a heat application in communication with said power generator or said power application. A method of low-emission power generation comprising: transferring power from a power source to a power generator; generating power; transferring power to a power grid and a power application; forming a power application product; generating heat from the power generator; and transferring the heat from the power generator to a heat application. A low-emission power generation system comprising: a first power train in communication with a power source and a first power application; a second power train in communication with said power source and said first power train; a temperature grade routing system; and a flexibility layer in communication with said first power train.

### CROSS-REFERENCE TO RELATED APPLICATIONS

This application claims priority to and the benefit of the filing of U.S. Provisional Patent Application No. 63/756,530, entitled “LOW-EMISSION POWER GENERATION SYSTEM AND METHOD”, filed on Feb. 10, 2025, and the specification and claims thereof are incorporated herein by reference.

### BACKGROUND OF THE INVENTION

### Field of the Invention (Technical Field)

The present invention relates to a system and method for low-emission power generation. More particularly, the invention relates to co-located power generation architectures and control methods that integrate high-efficiency power production, waste heat recovery, optional carbon capture, and/or a flexibility layer to supply power and thermal energy to an industrial power user while also supporting an external electric grid.

### Background

The global push for cleaner energy solutions has created market incentives for reduced emissions and increased energy efficiency among all industries. With increasing regulatory pressure to reduce emissions and the growing emphasis on sustainability, power plants need to achieve compliance with environmental standards while maintaining economic viability. Clean energy technologies are retrofitted into existing plants or incorporated into new builds.

Heat originating from industrial facilities and power plants is expelled into the ambient environment as waste. This waste heat is not recycled into the industrial facility or power plant. Additionally, both industrial facilities and power plants employ wasteful backup assets (e.g., generators) that have significant build costs, but remain ideal during periods of industrial facility and power plant operation. The capex for backup power ultimately is shifted to rate payers for power or industrial products. Backup assets also generate further waste that is not recycled into the industrial facility or power plant.

Industrial facilities and power plants are designed as an assemblage of components, but not co-located systems. A natural gas combined cycle plant converts only 66% of its input energy into electricity and discards the rest. A portion of this 66% may be directed to an industrial facility, which results in power line transmission losses where industrial facility and power plant are not co-located.

What is needed is a power generation system incorporating a power plant that achieves substantial cost and emissions savings from co-location of the power plants and power application and/or work application (e.g., compressors, pumps, and other rotating machinery) on the same campus; having the power plant co-located with a power input; including carbon capture where carbonaceous fuels are utilized; and configuring the power generation system to enhance the grid and drive down power prices by using recycled waste heat to create useable products and/or to make other parts of the process more efficient.

What is also needed is a power generation system with integrated systems and methods that co-locate power generation with industrial power users; convert idle reliability assets into productive prime mover capacity with high utilization; recover and redeploy waste heat through a temperature grade routing system; incorporate a flexibility layer for fast response and multi-product energy conversion; and provide power export and grid support services while maintaining high availability for critical industrial loads.

### BRIEF SUMMARY OF THE INVENTION

Embodiments of the present invention relate to a low-emission power generation system, the system comprising: a power source in communication with a power generator; the power generator in communication with a power application and a power grid; and a heat application in communication with the power generator or the power application. In another embodiment, the system further comprises a thermosiphon in communication with the power generator. In another embodiment, the system further comprises a gas separator in communication with the power generator. In another embodiment, the system further comprises a dynamic energy routing system. In another embodiment, the system further comprises a waste heat recovery system. In another embodiment, the system is configured to receive a carbon capture system as an add-on system. In another embodiment, the system further comprises a cooling cascade system.

Embodiments of the present invention also relate to a method of low-emission power generation, the method comprising: transferring power from a power source to a power generator; generating power; transferring power to a power grid and a power application; forming a power application product; generating heat from the power generator; and transferring the heat from the power generator to a heat application. In another embodiment, the power source comprises natural gas. In another embodiment, the power generator comprises a steam turbine configured for duct firing. In another embodiment, the method further comprises generating heat from the power application. In another embodiment, the method further comprises transferring the heat from the power application to the heat application. In another embodiment, the method further comprises producing a heat application product from the heat application. In another embodiment, the method further comprises cooling the power generator.

Embodiments of the present invention also relate to a low-emission power generation system, the system comprising: a first power train in communication with a power source and a first power application; a second power train in communication with the power source and the first power train; a temperature grade routing system; and a flexibility layer in communication with the first power train. In another embodiment, the flexibility layer comprises a third power train. In another embodiment, the system further comprises the flexibility layer in communication with a second power application. In another embodiment, the system further comprises the second power application in communication with a power grid. In another embodiment, the system further comprises the flexibility layer in communication with the power source. In another embodiment, the system further comprises the flexibility layer in communication with the second power train.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIGS. 1A and 1B are process flow diagrams showing comparative power distribution models, contrasting a traditional power plant structure (FIG. 1A, prior art) with a power plant co-located with the primary power user (FIG. 1B) according to an embodiment of the invention;

FIG. 2 is a process flow diagram showing a low-emission power generation system, according to an embodiment of the invention;

FIG. 3 is a process flow diagram showing a low-emission power generation system comprising primary and backup power capacities, according to an embodiment of the invention;

FIG. 4 is a process flow diagram showing a low-emission power generation system comprising gas separation components, optional inputs, and products, according to an embodiment of the invention;

FIG. 5 is a process flow diagram showing a power system, according to an embodiment of the invention;

FIG. 6 is a process flow diagram showing a power application and power application product system, according to an embodiment of the invention;

FIG. 7 is a process flow diagram showing heat applications and heat application products, according to an embodiment of the invention;

FIG. 8 is a process flow diagram showing a gas separator and gas products system, according to an embodiment of the invention;

FIG. 9 is a diagram showing modules for a low-emission power generation system, according to an embodiment of the invention; and

FIG. 10 is a diagram showing a low-emission power generation system and its co-products, according to an embodiment of the invention.

### DETAILED DESCRIPTION OF THE INVENTION

Embodiments of the present invention relate to a system for low-emission power generation, the system comprising: a power source in communication with a power generator; the power generator in communication with a power application and/or a power grid; and a heat application in communication with the power generator and/or power application. The system may further comprise a thermosiphon in communication with the power generator. The system may further comprise a gas separator in communication with the atmosphere, the power source, and/or the power generator. The system may further comprise a dynamic energy routing system configured to optimize power and/or optimize heat distribution. The system may further comprise waste heat recovery systems that drive power application and/or work application.

Embodiments of the present invention relate to a method for low-emission power generation, the method comprising: transferring power from a power source (including, but not limited to, natural gas, hydrogen, biofuels, solar, wind, and geothermal) to a power generator; generating power; transferring power to a power grid, power application, work application or a combination thereof; forming a power application product; generating heat from the power generator, power application, work application, or a combination thereof; and transferring heat to a heat application. The method may further comprise producing a power application product and/or a work application product. The method may further comprise producing a heat application product. The method may further comprise capturing carbon from the power source, power generator, power application, work application, or a combination thereof. The method may further comprise cooling the power generator, power application, work application, heat application, or a combination thereof. The method may further comprise separating atmosphere, flue gas, or other gas into gas products. The method may further comprise cooling the power generator, power application, work application, or a combination thereof with gas products and/or with water, an aqueous solution, a liquid (e.g., an organic liquid), or a combination thereof. The method may further comprise cooling the power generator, power application, work application, or a combination thereof with a thermosiphon.

Embodiments of the present invention also relate to a low-emission power generation system comprising: a first power train in communication with a power source and a first power application; a second power train in communication with the power source and the first power train; and a flexibility layer in communication with the first power train.

Embodiments of the present invention also relate to a method of low-emission power generation comprising: generating power from a first power train in communication with a power source to a first power application; generating power from a second power train in communication with the power source and the first power train to a grid; generating power from a flexibility layer in communication with the first power train; and transmitting power from the flexibility layer to a second power application.

The low-emission power generation system may be cost-neutral and compute-neutral wherein the power application is a data center. The low-emission power generation system may convert reliability and thermal budgets into shared, high-utilization infrastructure that benefits both the campus and the grid.

The low-emission power generation system may integrate power production, carbon capture, and waste heat utilization into a co-located energy ecosystem. By strategically placing power generators and/or power plants in proximity to high-energy-demand applications-such as data centers, industrial facilities, or chemical production plants—the low-emission power generation system may enhance energy efficiency, reduce emission, and improve economic viability of the low-emission power generation system.

Unlike conventional power plants that primarily deliver electricity to the grid, the low-emission power generation system comprises a dynamic energy routing system that optimizes on-site power use through a dynamic energy management framework. Surplus heat, which is typically lost in traditional power generation, may be captured and repurposed for carbon capture, process heating, cooling applications, desalination, chemical synthesis, other processes, or a combination thereof. Additionally, the low-emission power generation system may allow modular scalability, supporting configurations that prioritize either maximum grid support, self-sustaining energy loops, or hybrid power-distribution models.

Furthermore, the low-emission power generation system may comprise intelligent load balancing that enables real-time power allocation between the power generator, power-consuming applications, and external grid connections. Intelligent load balancing may reduce or eliminate the need for conventional backup generators, as the low-emission power generation system may redirect power and heat based on real-time demand and market conditions. By integrating carbon capture, heat recovery, and co-located industrial applications, this invention represents a next-generation energy system that minimizes waste, reduces environmental impact, and enhances energy security.

The low-emission power generation system may address the growing demand for sustainable and cost-effective data center operations, driven by the exponential increase in data processing and storage needs. The low-emission power generation system may reduce harmful emissions compared to other power generation systems including, but not limited to, NOₓ.

The system and method for low-emission power generation may integrate components related to power production, waste heat recovery, carbon capture, and a co-located power application and/or work application. The low-emission power generation may comprise a system for waste heat recovery that recovers heat from any component of the low-emission power generation system. The system and method for low-emission power generation may optimize energy use, minimize environmental impact, and enhance the economic performance of power generation facilities. The energy use may be optimized by a dynamic energy routing system. Specifically, the system and method for low-emission power generation may relate to power plants that are co-located with high-power applications-such as data centers, industrial processes, or chemical production facilities—to improve energy efficiency, reduce emissions, and improve overall system reliability.

The low-emission power generation system may comprise a power-to-X (“P2X”) technology. The P2X technology may balance the grid by absorbing excess renewable energy and converting it into storable and transportable fuels. These fuels may be used in sectors that are hard to electrify, such as aviation, shipping, and heavy industry.

The low-emission power generation system may comprise an energy management system (“EMS”). The EMS may contribute to the overall efficiency and sustainability of the power grid. By optimizing the operation of integrated cycles, the EMS may reduce fuel consumption, lower emissions, and improve the economic performance of the low-emission power generation system. The ability to integrate EMS may also support environmental goals and regulatory compliance. The demand for such an EMS may be driven by the increasing complexity of modern power grids, the integration of diverse energy sources, and the need for more responsive and intelligent grid management solutions.

The low-emission power generation system may comprise a heat exchange system. Integration of the heat exchange system into a low-emission power generation system may result in significant energy savings, reduced operational costs, and lower environmental impact. Data centers, being energy-intensive facilities, benefit from reduced electricity consumption for cooling, while power plants improve their overall thermal efficiency.

The low-emission power generation system may comprise a gas separator, e.g., an air separation unit (“ASU”). The gas separator may be integrated with at least one component of the low-emission power generation system. Integration of the gas separator may increase efficiency, lower operational costs, and reduce emissions of the low-emission power generation system. The gas separator may be configured to be used in combination with different types of power generation, with data center operations, and with industries involved in CO₂ use and storage.

This technology is particularly relevant as data centers continue to grow in size and energy demands increase. A low-emission power generation system comprising a power plant and a data center may leverage integration of an ASU to offer competitive services and enhance their sustainability profiles compared to traditional systems. A power plant and a data center may be co-located in a low-emission power generation system located at technology companies, utilities, and/or an industrial park.

The low-emission power generation system may comprise a cooling system. The cooling system may be used to cool data centers, semiconductor manufacturing, and other industries where thermal management is important to performance and reliability. By achieving lower temperatures, equipment may operate more efficiently and with greater longevity.

The low-emission power generation system may comprise a system for producing nitrogen in a gaseous, liquid, solid, supercritical state, or a combination thereof. The nitrogen may be used to cool components of the low-emission power generation system, e.g., data centers, and may reduce energy consumption associated with traditional cooling methods, lower operational costs, and improve the environmental footprint of the low-emission power generation system. The improved cooling and reduced energy consumption may be achieved where the low-emission power generation system comprises a power application and/or a work application co-located with an ASU and/or a power generator employing oxy-combustion. Nitrogen cooling may allow the use of hyperscale data centers, high-performance computing facilities, and industries where cooling is a significant operational challenge.

The low-emission power generation system may comprise a desalination system. The desalination system may process waste heat and may contribute to addressing water scarcity challenges while improving low-emission power generation system energy efficiency. The desalination system may be used in regions where fresh water is limited, and energy-intensive desalination is a necessity. The desalination system may be used in a low-emission power generation system located near a coast, comprising an industrial facility, and/or located in a region investing in desalination infrastructure.

The low-emission power generation system may comprise an organic Rankine cycle (“ORC”) system. The ORC system may generate additional electricity from waste heat that would otherwise be dissipated and may improve energy use and reduce operational costs.

The low-emission power generation system may comprise a power cycle using working fluids not typically associated with ORC systems, including by way of example but without limitation, CO₂, argon, and nitrogen, which working fluids may or may not be persistently or episodically in a supercritical state. This system may generate additional electricity from waste heat that would otherwise be dissipated and may improve energy use and reduce operational costs.

The low-emission power generation system may comprise thermal energy storage. The thermal energy storage may store excess heat during periods of low demand and release it when needed, reducing reliance on peak energy generation. The thermal energy storage may capture and use waste heat that would otherwise be lost, thereby enhancing overall system efficiency. The thermal energy storage may balance intermittent renewable energy sources by storing excess thermal energy for use during low-generation periods.

The low-emission power generation system may employ carbon capture and/or storage (“CCS”) with waste heat used to reduce the energy penalty typically associated with carbon capture, making carbon capture more economically viable.

The low-emission power generation system may employ dynamic computing relocation to identify ideal geographical locations for a low-emission power generation system. Dynamic computing relocation may lower operational expenses by using locations with cheaper energy or excess renewable generation. Dynamic computing relocation may enhance overall energy use by aligning compute demand with energy supply, particularly renewable sources. Dynamic computing relocation may improve system reliability by distributing workloads across multiple locations, reducing the impact of localized outages or disruptions.

The low-emission power generation system may comprise an absorption cooling system. The absorption cooling system may reduce electricity consumption by utilizing waste heat instead of electric compressors. The absorption cooling system may lower energy and operational costs compared to traditional systems, particularly in regions with high electricity prices. The absorption cooling system may decrease greenhouse gas emissions associated with electricity generation, contributing to sustainability goals. The absorption cooling system may comprise fewer moving parts compared to traditional systems, resulting in quieter operation and reduced maintenance compared to mechanical chillers.

The low-emission power generation system may comprise an enhanced refrigeration system. The enhanced refrigeration system may reduce reliance on electrically driven compressors, lowering energy consumption and operational costs. The enhanced refrigeration system may reduce the use of refrigerants compared to traditional systems and leverage waste heat contributions to lower greenhouse gas emissions. The enhanced refrigeration system may have fewer moving parts compared to traditional systems and may result in reduced wear and tear, leading to lower maintenance requirements and longer system lifespans.

The low-emission power generation system may comprise a system to transfer heat beneath the surface of the earth and/or into the earth. The system to transfer heat may comprise a heat sink. The heat sink may permanently or temporarily transfer heat beneath the surface of the earth and/or into the earth. The heat sink may include, but is not limited to, aquifers, a subterranean pore space, a sub-surface reservoir, a sub-surface cavern, other sub-surface void, or a combination thereof. The system to transfer heat may comprise a thermally conductive medium, e.g., clay. The thermally conductive medium may act as a heat sink. The system to transfer heat beneath the surface of the earth and/or into the earth may comprise a working fluid including, but not limited to, water, an aqueous solution, a saline solution, CO₂, air, nitrogen, argon, or a combination thereof. The working fluid may be in a gaseous, solid, liquid, and/or supercritical state.

The low-emission power generation system may allow a data center to convert waste heat, an operational cost, into a revenue stream (e.g., by selling heat, CO₂-based products). The low-emission power generation system may reduce or eliminate waste by using every unit of energy and matter more than once. This may reduce overall operational costs, improve margins, and help achieve deflationary trends in energy and material costs. The low-emission power generation system's integrated carbon capture system and industrial reuse of carbon stream may reduce emissions compared to a traditional power plant. Instead of venting CO₂ into the atmosphere, the CO₂ may be used to grow algae or produce synthetic fuels. The low-emission power generation system may move a data center complex closer to carbon neutrality, if not carbon negativity. With multiple revenue streams—power sales, carbon credits, chemical products, biofertilizers—the low-emission power generation system may adapt to changing market conditions. For example, the low-emission power generation system may profit from CO₂-based chemical production if electricity prices drop, and/or sequestering more CO₂ or enhancing algae growth if carbon credits increase in value.

The low-emission power generation system may comprise a nutrient recovery and/or biofuel production system. Produced biofuels may be used as alternative energy sources. The nutrient recovery system may convert organic waste and wastewater into valuable products such as methane or clean water. The nutrient recovery and/or biofuel production system may improve efficiency of the low-emission power generation system by using waste heat, reducing the need for additional energy inputs. The nutrient recovery and/or biofuel production system may create revenue streams from biofuel sales and nutrient recovery and may enhance the profitability of the low-emission power generation system.

The low-emission power generation system may be modular and may be configured to comprise a hub designed for attachment of various systems, such as a thermal loop or CO₂ pipeline. The modularity may allow the low-emission power generation system to add, remove, or change modules depending on market conditions, AI workloads, and evolving technologies. The low-emission power generation system modules may each comprise a power generator, power application, work application, or a combination thereof. Each module may independently operate other modules and may be activated or powered off without affecting the operation of any other modules. Power may be routed to or from one or more modules. The low-emission power generator module may allow the low-emission power generation system to be more reliable than traditional power plants and/or reduce the equipment required for backup power.

The low-emission power generation system may function as a circular economy integration hub. A traditional data center model treats energy, cooling, and byproducts like heat and CO₂ as mere operational overheads or waste streams. The circular economy integration hub uses output or waste product from one process (e.g., heat from a data center) as an input for another process (e.g., heat for powering an electrolyser). By co-locating a power application (e.g., a data center) and/or a work application (e.g., a pump and/or compressor), and a low-cost power generation facility (e.g., natural gas or geothermal power), carbon capture systems, and downstream industrial or agricultural partners to form a low-emission power generation system, efficiency may be improved, costs may be lowered, emissions may be reduced, and additional revenue streams may be generated from process products and byproducts. The circular economy integration hub may organize and manage flows of energy, heat, carbon, nutrients, and other resources. The circular economy integration hub may ensure that power application and/or work application waste heat is not lost to the atmosphere, that captured CO₂ is not a disposal headache but a valuable commodity, and that the entire facility operates more like an ecosystem than a standalone building by leveraging advanced data analytics and control systems.

The low-emission power generation system may operate by providing power from a power generator to a power application. Power may be provided from a single power generator to a single power application; a plurality of power generators to a single power application; a plurality of power generators to a plurality of power applications; or a single power generator to a plurality of power applications. Excess power and/or heat from the power generator and/or power application may be sent to a plurality of individual power users via a power grid. Traditional power generation systems operate by providing power to a plurality of individual power users via a power grid.

The term “power source” as used herein means a substance capable of providing power. The power source may include, but is not limited to, natural gas, syngas, coal, oil, oxygen gas, hydrocarbons, hydrogen, ammonia, another combustible fluid, or a combination thereof.

The term “power application” as used herein means a system or process that uses generated power, e.g., a data center, to generate an output, e.g., data or bits.

The term “work application” as used herein means a process that uses generated work, e.g., a pump, compressor, or other apparatus, to convey a working fluid throughout a power source, power application, other component of a low-emission power generation system, or a combination thereof.

The term “heat application” as used herein means a system or process, e.g., an electrolyzer, that uses heat as an input to generate an output, e.g., a product.

The term “power application input” as used herein means data or material that is received by a power application.

The terms “simple cycle gas turbine” and “SCGT” as used herein mean a gas turbine that uses a single power cycle to produce power (e.g., electricity).

The term “steam turbine” and “ST” as used herein means a turbine that uses steam to produce power (e.g., electricity). The steam turbine may be configured for duct firing.

The terms “combined cycle gas turbine” and “CCGT” as used herein mean a gas turbine that directs exhaust heat to a heat recovery steam generator and an associated steam turbine.

The terms “reciprocating engine,” “reciprocating internal combustion engine,” and “RICE” as used herein means a reciprocating engine to produce power (e.g., electricity).

The terms “simple cycle power plant” and “SCPP” as used herein mean a power plant that uses a one or more SCGTs and/or RICEs to produce power.

The terms “combined cycle power plant” and “CCPP” as used herein mean a power plant that combines one or more SCGTs and/or RICEs and uses the exhaust heat therefrom to generate steam and to convert that steam into power through a steam turbine with a heat recovery steam generator.

The terms “heat recovery steam generator” and “HRSG” as used herein mean an energy recovery heat exchanger that recovers heat from a fluid stream. The fluid stream may be from a combustion turbine and/or a waste gas stream. The heat recovery steam generator may generate steam that may be used in a process or operate a steam turbine that produces work that may include power.

The term “working fluid” as used herein means a circulated fluid used in a thermodynamic process and may be subjected to heating, cooling, condensation, and/or expansion.

The terms “air separation unit” and “ASU” as used herein mean an apparatus that separates atmospheric air into its primary components. The primary components include, but are not limited to, oxygen, carbon dioxide, and nitrogen.

The terms “organic Rankine cycle” and “ORC” as used herein mean a thermodynamic cycle using any working fluid (including, but not limited to, organic working fluids) with a vaporization temperature lower than water or, alternatively above 100° C.

The term “supercritical fluid” as used herein means matter that exists at a temperature and pressure above its critical point where distinct gas and liquid phases are absent, and below the pressure required to compress the matter into a solid.

The term “thermosiphon” as used herein means an apparatus that uses convection and conduction to convey a fluid from a region of high heat to low heat and from a region of low heat to high heat without use of a mechanical pump.

The term “bioreactor” as used herein means an apparatus that maintains an environment to facilitate a biochemical reaction and/or process.

The term “power” as used herein means electric energy.

The terms “power-to-X” and “P2X” as used herein mean a set of processes that convert electrical energy, which may be from renewable sources, into chemical energy carriers such as hydrogen, methane, or liquid fuels.

The term “carbon” as used herein includes sources of carbon including, but not limited to, carbon dioxide, carbon monoxide, or other gaseous carbon oxides.

The terms “grid” and “electrical grid” are used interchangeably throughout this application.

The term “temperature grade routing system” as used herein means a system configured to capture and route thermal energy from one or more sources to one or more heat applications.

The term “cooling cascade” as used herein means a system configured to route different grades of cold to different cooling applications.

The terms “industrial power user” or “power application” are used interchangeably throughout this application and mean any facility, process, or collection of equipment that consumes electrical power and that benefits from high availability and/or power quality. An industrial power user or power application may include, but is not limited to, a data center, semiconductor fabricator, chemical plant, refinery, electrolyzer, compressor station, manufacturing line, mining operation, water treatment facility, energy plant, or a combination thereof. Only a portion of the power demand of a power application may be treated as a critical power load with non-critical power loads being controllable and/or deferrable.

The terms “train” or “power train” are used interchangeably herein and mean any apparatus configured to produce and route electrical power, thermal power, or other power products (e.g., light). The train or power train may include, but is not limited to, one or more prime movers, generators, heat recovery equipment, power electronics, switchgear, associated auxiliaries, or a combination thereof.

As used herein “N-train” refers to a power train producing and routing electrical power, thermal power, or other power products to a power application and/or grid.

As used herein “F-train” refers to a power train producing and routing electrical power, thermal power, or other power products to a power train, power application, and/or heat application.

The term “prime mover” as used herein means any turbine, reciprocating engine, combustion engine, engine, fuel cell, electrochemical cell, or other device that converts fuel and/or other energy input into mechanical, chemical, and/or thermal energy for power generation.

The term “flexibility layer” means the components and control functionality configured to provide fast response, buffering, energy shifting, and/or conversion of energy into storable and/or saleable forms. The flexibility layer may comprise a power train and a heat application. The flexibility layer may comprise, but is not limited to, electrochemical storage, thermal storage, cold storage, controllable loads, a power-to-X system, a hydrogen production system, a thermal battery (e.g., molten salt thermal storage), an electrochemical battery, or a combination thereof.

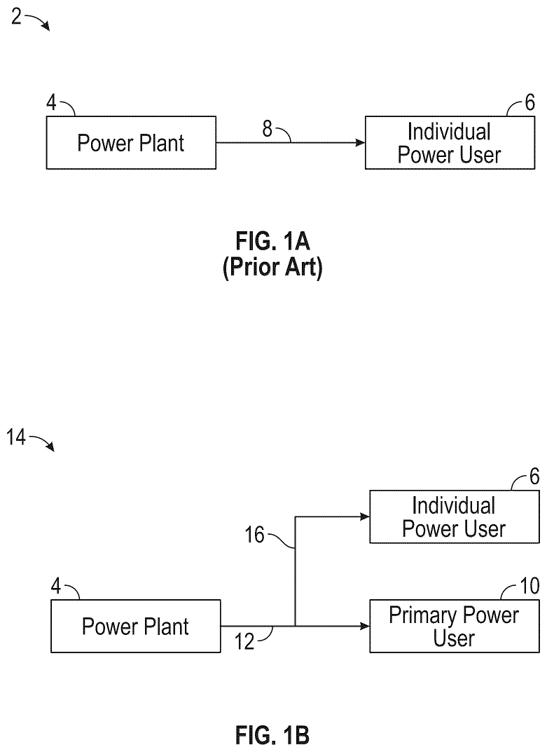

Turning now to the figures, FIGS. 1A and 1B show power plant power distributions 2 and 14, respectively. FIG. 1A shows traditional power plant distribution 2. In power plant distribution 2, power plant 4 routes power 8 to individual power user 6. In contrast, power plant distribution 14 shows power plant 4 routing power 12 to primary power user 10, which may be a power application such as a data center or chemical plant, and/or a work application such as rotating machinery. Excess power 16 is routed to individual power user 6. In power plant distribution 14 the primary power user is the main recipient of power rather than individual power user 6.

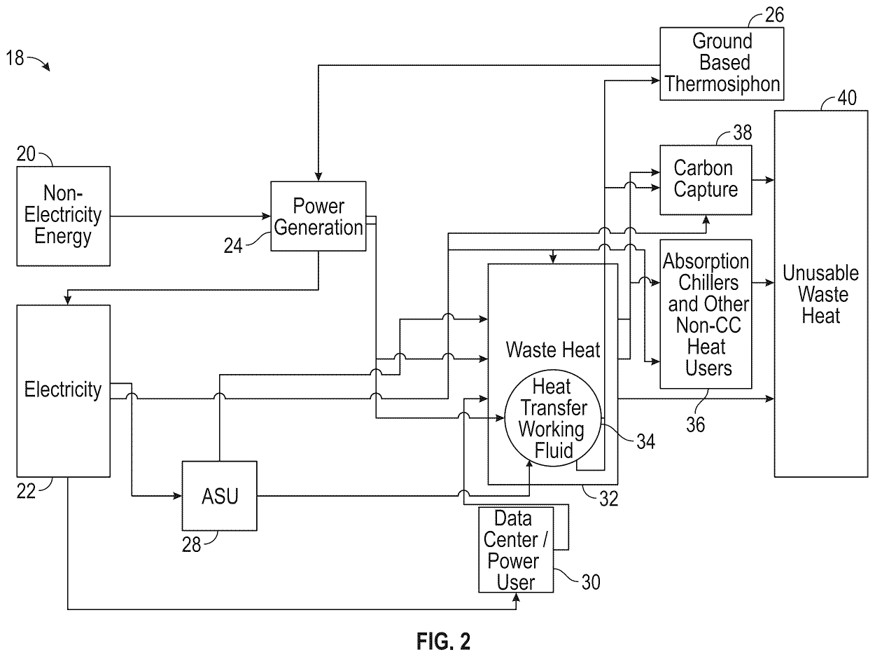

FIG. 2 shows low-emission power generation system 18. Low-emission power generation system 18 comprises non-electric energy 20, power generation system 24, electricity 22, ASU 28, data center or power user 26, waste heat 32, heat transfer working fluid 34, ground based thermosiphon 26, carbon capture system 38, absorption chiller or other non-carbon capture heat user 36, and unusable waste heat 40. Non-electric energy 20, e.g., natural gas, is passed into power generation system 24. Power generation system 24 produces electricity 22, which is used to power ASU 28 and data center or power user 30. Power generation system 24, ASU 28, and data center or power user 30 produce waste heat 32. Heat transfer working fluid 34 absorbs waste heat 32 to transfer heat to carbon capture process 38 and absorption chiller or other non-carbon capture heat user 36, and ground based thermosiphon 26. Waste heat 32, carbon capture process 38, and absorption chiller or other non-carbon capture heat user 36 produce unusable waste heat 40. Ground based thermosiphon 26 returns electrical energy to power generation system 24.

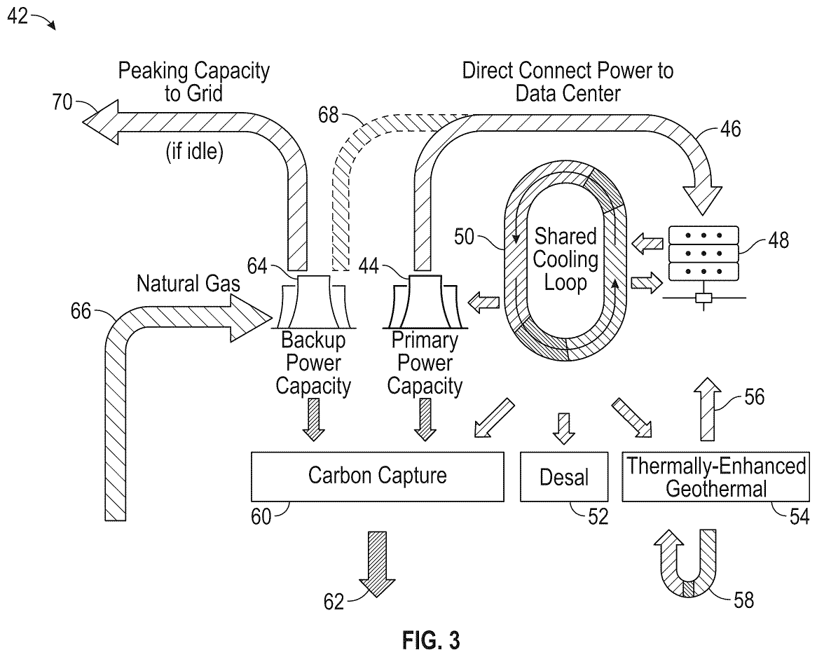

FIG. 3 shows low-emission power generation system 42. Low-emission power generation system 42 comprises primary power capacity 44, backup power capacity 64, shared cooling loop 50, and data center 48. Natural gas 66 enters primary power capacity 44 (e.g., a power plant) which provides power to a power grid (not shown), direct connect power 46 to data center 48, and which provides carbon for carbon capture 60. Shared cooling loop 50 obtains heat from data center 48 to provide usable heat to primary power capacity 44, carbon capture 60, desalination process 52, and thermally enhanced geothermal system 54. Thermally enhanced geothermal system 54 converts cold working fluid to hot working fluid 58 to generate power 56 for data center 48. Natural gas 66 and/or primary power capacity 44 provide fuel and/or power for backup power capacity 64, which stores energy. Depending on power requirements, backup power capacity 64 transfers peaking capacity 70 to power grid, provides power 68 to data center 48, and/or generates carbon for carbon capture 60. Carbon capture 60 produces carbon products 62 including, but not limited to, carbonates.

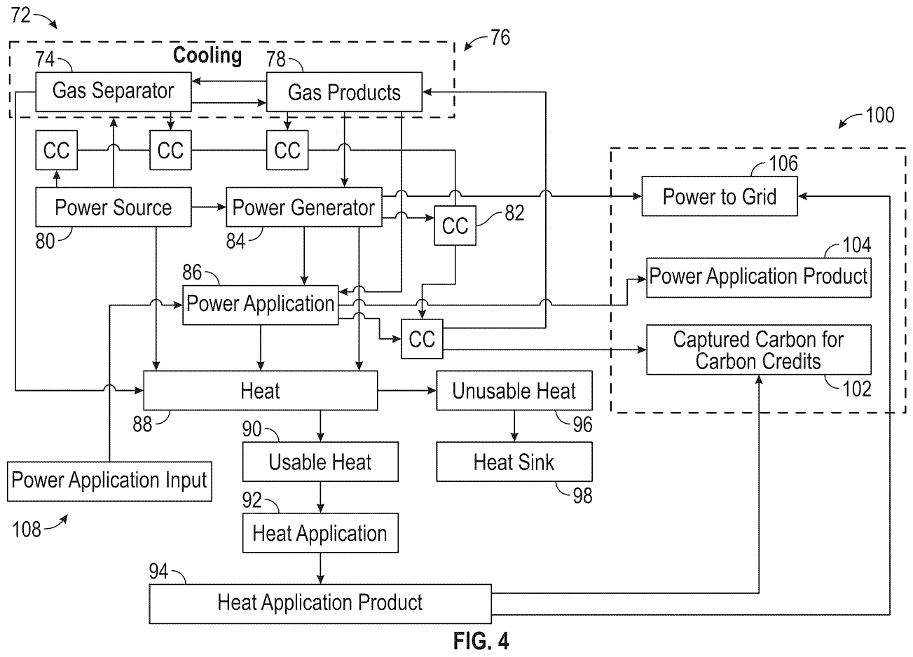

FIG. 4 shows low-emission power generation system 72. Low-emission power generation system 72 comprises power source 80, power generator 84, power application 86, heat application 92, cooling system 76 comprising gas separator 74 and gas products 78, and carbon capture systems 82. Power source 80 provides gas to power generator 84. Optionally, waste gas from power source 80 passes to gas separator 74. Power generator 84 provides power to grid 106, and power to power application 86. Power application 86 produces power application product 104. Power source 80, power generator 84, and power application 86 generate heat 88. Heat 88 is separated into unusable heat 96 and usable heat 90. Unusable heat 96 is sent to heat sink 98. Usable heat 90 is transferred to heat application 92. Heat application 92 produces heat application product 94. Heat application product 94 may include captured carbon for carbon credits 102 and power to grid 106. Optionally, power application input 108 is sent to power application 86 to increase the efficiency of power application 86. Gas separator 74 creates gas products 78 used to cool power generator 84 and power application 86. Power course 80, power generator 84, and power application 86 create carbon that is sent to carbon capture system 82. Carbon capture system 82 produces captured carbon for carbon credits 102. Power to grid 106, power application product 104, and carbon capture for carbon credits 102 are products 100 of low-emission power generation system

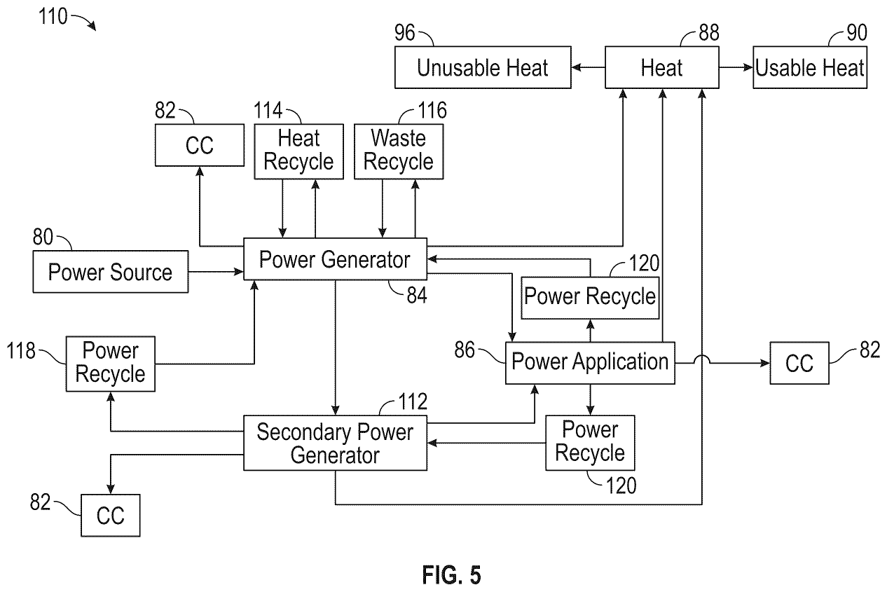

FIG. 5 shows power system 110. Power system 110 comprises power source 80, power generator 84, secondary power generator 112, power application 86, heat recycle system 114, waste recycle system 116, power recycle systems 118 and 120, and carbon capture system 82. Power source 80 provides fuel for power generator 84. Heat and waste, e.g., flue gas, are recycled to power generator 84 by heat recycle system 114 and waste recycle system 116, respectively. Power generator 84 may be a simple cycle gas turbine or combined cycle gas turbine. Power generator 84 conveys waste heat to secondary power generator 112. Secondary power generator 112 may be a heat recovery steam generator. Optionally, power recycle system 118 returns power to power generator 84. Power generator 84 and secondary power generator 112 provide power to power application 86. Optionally, power recycle systems 120 return power from power application 86 to power generator 84 and/or secondary power generator 112. Optionally, power generator 184, secondary power generator 112, and power application 86 provide carbon to carbon capture systems 82. Power generator 84, secondary power generator 112, and power application 86 generate heat 88, which is separated into unusable heat 96 and usable heat 90.

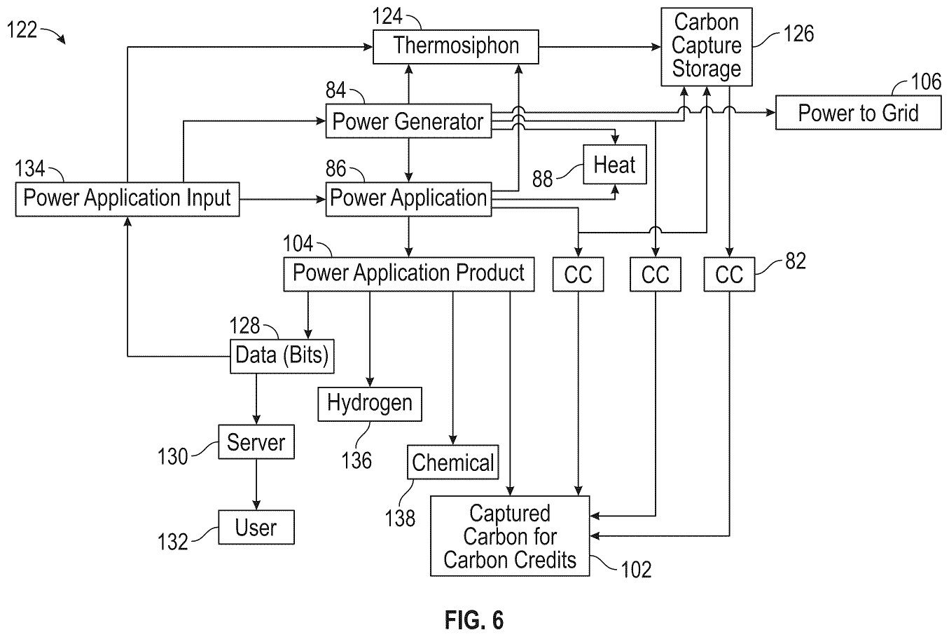

FIG. 6 shows power application and power application product system 122. Power application and power application product system 122 comprises power generator 84, power application 86, power application product 104, thermosiphon 124, power application input 134, carbon capture storage 126, and a plurality of carbon capture systems 82. Power generator 84 provides power to grid 106, power to power application 86, and heat 88. Power application 86 provides power application product 104 and heat 88. Thermosiphon 124 cools power generator 84 and power application 86. Thermosiphon 124 may also comprise a carbon capture system. Thermosiphon 124, power generator 84, power application 86 may each produce carbon to be passed into carbon capture systems 82 or carbon capture storage 126. Carbon stored in carbon capture storage 126 may be passed into carbon capture systems 82. Carbon capture storage 126 may be an above-ground or subterranean storage area. Carbon from carbon capture systems 82 is used as captured carbon for carbon credits 102. Where power application product 104 is a data center, power application product 104 produces data 128 that is transferred to server 130 and user 132. Optionally, data 128 may be transferred to power application input 134. Power application input 134 is a computational and controller module that feeds data to computer controllers for power generator 84, power application 86, and/or thermosiphon 124 to optimize and/or increase their efficiency. For example, the data produced by power application 86 may include instructions to regulate the power of power application 86 to increase or decrease data center power usage depending on power grid demands. A data center may receive less power during peak energy demand during the day. Where power application 86 is an electrolyzer, power application product 104 may be hydrogen 136 or another chemical 138. The electrolyzer may be for the electrolysis of water or a chlor-alkali process. Chemical 138 may include, but is not limited to, oxygen, chlorine, sodium hydroxide, ammonia, or a combination thereof.

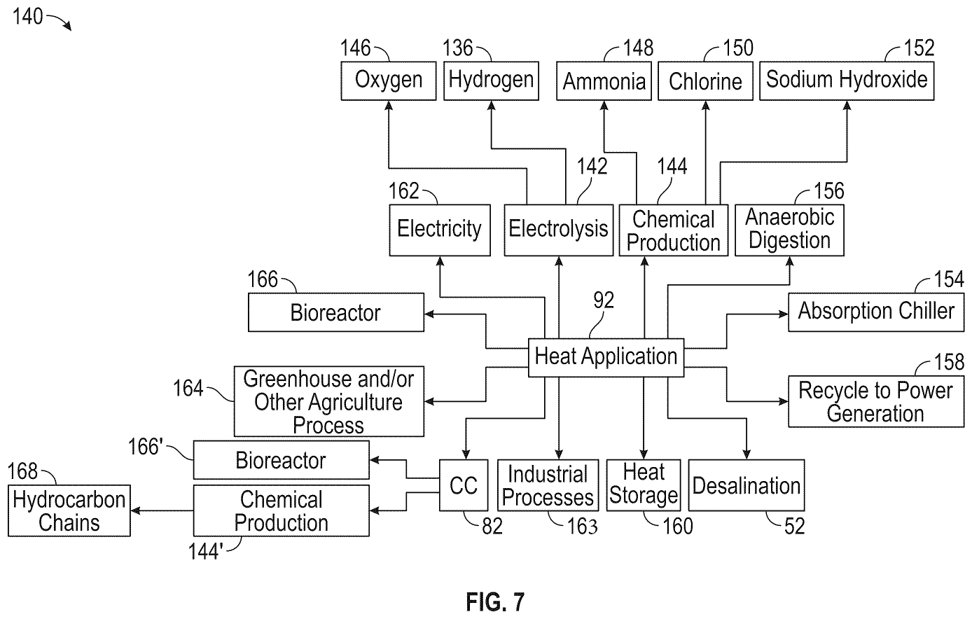

FIG. 7 shows heat application and heat application products diagram 140. Heat application 92 includes heat that is optionally used to generate electricity 162, heat bioreactor 166, heat greenhouse and/or other agricultural process 164, and/or absorption chiller 154. Heat from heat application 92 may also be used for carbon capture 82, industrial processes 163, heat storage 160, desalination 52, recycle to power generation 158, anaerobic digestion 156, chemical production 144, and electrolysis 142. Carbon dioxide from carbon capture 182 may be conveyed to bioreactor 166′ and/or used chemical production 144′, which include hydrocarbons chains 168. Chemical production 144 yields ammonia 148, chlorine 150, and sodium hydroxide 152. Electrolysis yields hydrogen 136 and oxygen 146.

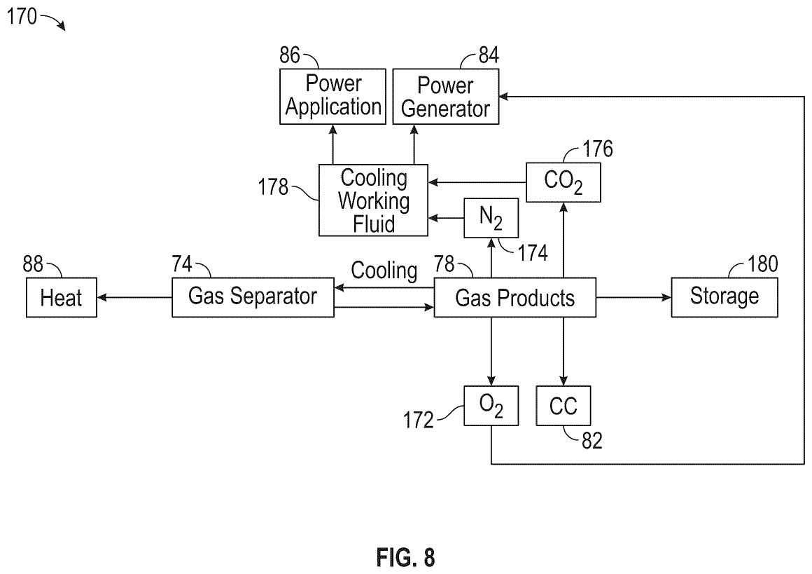

FIG. 8 shows gas separator and gas products system 170. Gas separator and gas products system 170 comprises gas separator 74, gas products 78, storage 180, carbon capture system 82, nitrogen 174, carbon dioxide 176, oxygen 172, cooling working fluid 178, power application 86, and power generator 84. Gas separator 74 separates atmosphere into gas products 78. Gas products include oxygen 172, nitrogen 174, and carbon dioxide 176, each of which may be stored in storage 180 as a liquid, gas, or a combination thereof. Oxygen 172 may be sold as a product or passed into power generator 84. Carbon dioxide 176 may be passed into carbon capture system 82 and converted to supercritical CO₂ to act as cooling working fluid 178 for power application 86 and/or power generator 84. Nitrogen 174 may be in liquid form and acts as cooling working fluid 178 for power application 86 and/or power generator 84. Nitrogen 174 and carbon dioxide 176 may each act as cooling working fluid 178 or may be used in combination. Heat 88 from gas separator 74 may be used in a heat application.

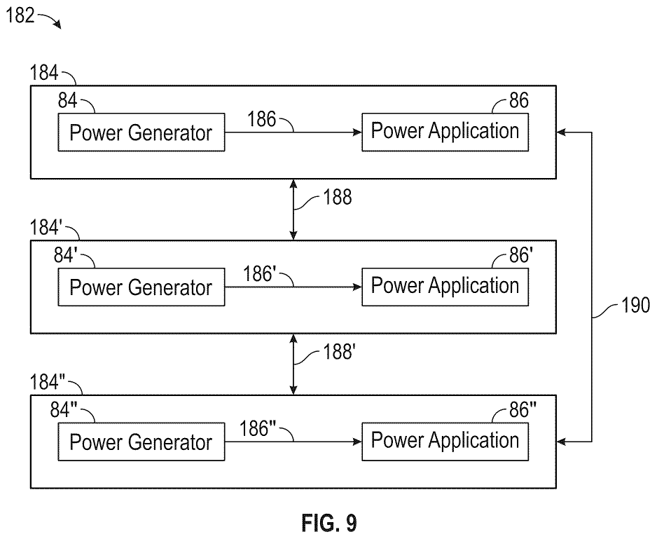

FIG. 9 shows low-emission power generation system module 182. Low-emission power generation system module system module 182 comprises modules 184, 184′, and 184″. Module 184 comprises power generator 184 and power application 186. Power generator 184 routes power 186 to power application 186. Module 184′ comprises power generator 184′ and power application 186′. Power generator 184′ routes power 186′ to power application 186′. Module 184″ comprises power generator 184″ and power application 186″. Power generator 184″ routes power 186″ to power application 186′. Power 188 may be routed between modules 184 and 184′ depending on the power output of power generators 184 and 184′ and of power applications 186 and 186′. For example, additional power may be routed to power application 186 from power generator 184′. As with power 188, power 188′ may be routed between modules 184′ and 184″ to accommodate the power needs of modules 184′ and 184″. As with power 188, and 188′, power 190 may be routed between modules 184 and 184″ to accommodate the power needs of modules 184 and 184″. Any module 184, 184′, or 184″ may be deactivated or have its power reduced or increased without affecting the power output of any other module.

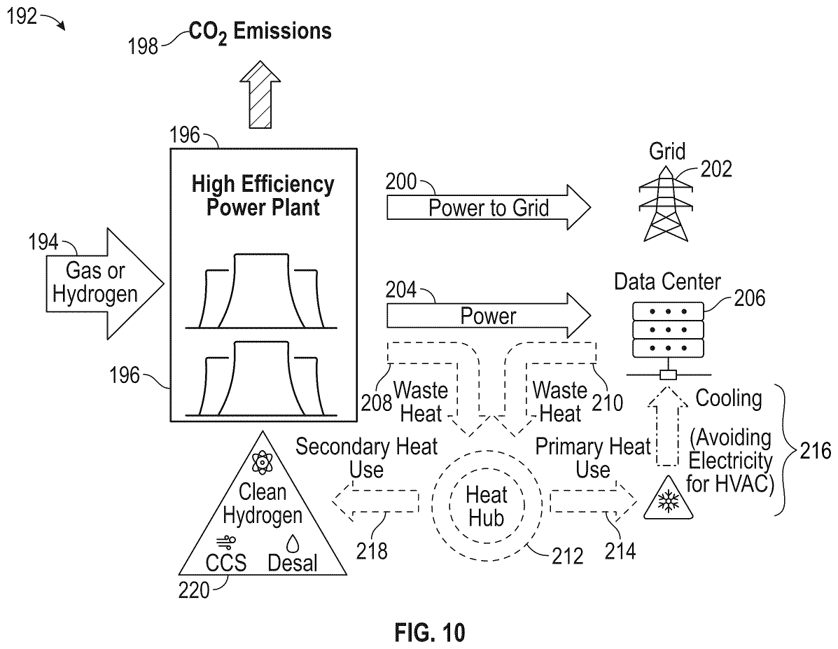

FIG. 10 shows low-emission power generation system and its co-products 192. Gas or hydrogen 194 enters high efficiency power plant 196 producing CO₂ emissions 198, power 200 to power grid 202 and power 204 to data center 206. High efficiency power plant waste heat 208 and data center waste heat 210 enter heat hub (i.e., temperature grade routing system) 212 to produce primary heat use 214 and secondary heat use 218. Primary heat use 214 powers and/or drives cooling 216 to cool data center 206. Secondary heat use 218 powers and/or drives a heat application to produce heat application products 220.

The low-emission power generation system may comprise a power source. The power source may include, but is not limited to, natural gas, coal, biofuel, hydrocarbons, organic fluid, hydrogen, or a combination thereof.

The low-emission power generation system may comprise a power generator. The power generator may include, but is not limited to, a SCGT, a CCGT, a RICE, a HRSG, an Allam-Fetvedt cycle, or a combination thereof. The power generator may comprise a combustion turbine, a steam turbine, or a combination thereof.

The power generator may comprise or be in communication with a capacity boosting module. The capacity boosting module may boost the power capacity of the power generator. The capacity boosting module may boost the power capacity of any turbine including, but not limited to, a combustion turbine, a steam turbine, or combination thereof.

The capacity boosting module may comprise an inlet air cooling system. The inlet air cooling system may be configured to reduce intake air temperature, increasing input fluid density, increase power output, or a combination thereof. The inlet air cooling system may comprise a mechanical chiller, an evaporative cooler, an air separator unit, a fogger, or a combination thereof.

The capacity boosting module may comprise a water and/or steam injector. The water and/or steam injector may be configured to increase mass flow into the power generator, enhance power output, reduce NOₓ emission or a combination thereof.

The capacity boosting module may comprise an overfiring system. The overfiring system may allow the power generator to overfire. Alternatively, the power generator may be configured to overfire. Overfiring the power generator may increase turbine inlet temperature (“TIT”). Raising the TIT above standard limits of the power generator may increase the power output of the power generator.

The capacity boosting module may comprise a wet compressor. The wet compressor may allow the power generator to over-fog beyond saturation and/or enhance the mass flow and cooling throughout the power generator.

The power generator may comprise a turbine configured to overspeed. Overspeeding the power generator may allow the power generator to operate above nominal speed (e.g., about 105% of nominal speed).

The power generator may comprise a turbine configured to increase steam temperature and pressure beyond normal operational parameters. Increasing steam temperature and pressure beyond normal operational parameters may raise enthalpy and boost power output.

The power generator may comprise a turbine configured to overload valve operation. Overloading the valve operation may allow additional steam bypass to increase power.

The power generator may comprise a turbine configured to reduce condenser pressure. Reducing the condenser pressure may improve steam expansion efficiency by lowering exhaust pressure.

The power generator may comprise a turbine configured to achieve sliding pressure operation. Sliding pressure operation uses variable steam pressure instead of throttling.

The power generator may comprise a turbine configured to inject superheated steam. Injecting superheated steam may supplement steam injection into intermediate turbine sections.

The power generator may comprise a turbine configured to employ advanced steam path optimization. Advanced steam path optimization may comprise adjusting blade angles for optimized gas and/or steam expansion within the turbine.

The power generator may comprise a turbine configured to optimize condensate preheating and feedwater. Optimizing condensate preheating and feedwater may enhance feedwater efficiency using extracted steam.

The low-emission power generation system may comprise a subcritical CO₂ working fluid and a subcritical CO₂ power cycle. The power cycle may be an Allam-Fetvedt cycle, but operate with a subcritical CO₂ working fluid. Carbon dioxide (CO₂) may be the working fluid in a semi-closed-loop system and operating at subcritical pressures. The power cycle using subcritical CO₂ may operate in conjunction with simple cycled gas turbine, combined cycle gas turbine, or a combination thereof.

In the subcritical CO₂ power cycle, fuel combustion may occur with pure oxygen supplied by an air separation unit (“ASU”), in an oxy-combustion process. By eliminating nitrogen from the combustion process, the formation of nitrogen oxides (NOₓ), harmful pollutants, may be avoided. The primary combustion products may be CO₂ and water vapor, which may be separated. The water vapor may be condensed, leaving a high-purity CO₂ stream that may be captured for sequestration or utilization.

The low-emission power generation system may comprise a NOₓ reduction component for lowering the concentration of, removing, and/or converting NOₓ. The NOₓ reduction component may be in communication with any other component of the low-emission power generation system including, but not limited to, the rear of a flue stack of a power generator. The NOₓ reduction component may comprise a catalyst for converting NOₓ to another compound; a scrubber; a filter; a sorbent for adsorbing NOₓ; or a combination thereof. The low-emission power generation system may be configured to use heat to enhance NOₓ reduction component. The power generator of the low-emission power generation system may be configured to perform a partial oxy-combustion in to reduce NOₓ emission. The ASU of the low-emission power generation system may be configured to use cold nitrogen byproduct to quench a post-flame that may be produced by the low-emission power generation system and/or lower the temperature of the power generator to reduce NOₓ emission.

The subcritical CO₂ power cycle may achieve high recuperation. Waste heat from the exhaust may be recovered through heat exchangers and reintroduced into the subcritical CO₂ power cycle, improving thermal efficiency. The use of CO₂ as a working fluid offers advantages such as higher density and heat capacity compared to steam. Operating at subcritical pressures may avoid the complexities and high costs associated with materials that may withstand supercritical conditions.

The low-emission power generation system may comprise a gas separator. The gas separator may comprise an ASU. The gas separator may separate atmosphere into primary gases including, but not limited to, oxygen, nitrogen, carbon dioxide, and argon. The oxygen may be used for combustion in a power generator and/or allow CO₂ capture due to the absence of nitrogen in the flue gas from the power generator. The nitrogen may be used for cooling any component of the low-emission power generation system. The nitrogen may also be used to produce ammonia, fertilizer, another nitrogen-containing compound, or a combination thereof.

Cold energy released during the ASU process may be used to liquefy CO₂ captured from the combustion process. Liquefying CO₂ facilitates easier transport and storage.

The low-emission power generation system may comprise a working fluid. The working fluid may include, but is not limited to, CO₂, N₂, an organic fluid, e.g., isopentane and/or pentane, an aqueous solution, water, or a combination thereof. The working fluid may be a supercritical fluid, a fluid, a gas, or a combination thereof.

The low-emission power generation system may supplement or replace a power backup. The power backup may include, but is not limited to, a standby generator; a portable power generator; a solar battery storage system; a light tower; a backup stationary generator; a battery storage system; a mobile generator; a backup hydrogen fuel cell; a microgrid; or a combination thereof. The power backup may be one used by a traditional power plant to provide power in the event of a power failure.

The low-emission power generation system may comprise a shared cooling system. The shared cooling system may simultaneously and/or sequentially cool at least part of the power application (e.g., a data center) and/or the work application (e.g., rotating machinery) and/or power generator (e.g., a reciprocating engine, a simple cycle, a combined cycle gas turbine, a steam turbine, or a combination thereof). The shared cooling system may be integrated and/or in communication with the power application, work application, power generator, power plant, or a combination thereof. The shared cooling system may enhance energy efficiency and/or reduce the operational costs of the low-emission power generation system via shared infrastructure for thermal management.

The low-emission power generation system may comprise a common cooling loop. The common cooling loop may comprise a shared cooling circuit comprising a working fluid that is integrated with and/or is in communication with any component of the power application, work application, power generator, and/or power plant including, but not limited to, a cooling tower, chiller, heat exchanger, heat sink (e.g., an underground aquifer, a ground loop, and/or cooling pond) or a combination thereof. The common cooling loop may optimize a component of the power application, work application, power generator, power plant, or a combination thereof. The common cooling loop may recover waste heat from the power generator and/or power plant and repurpose it for absorption cooling or heating within the power application and/or the work application. The common cooling loop may be configured to balance the power load between the power application, the work application, the power plant, or a combination thereof, by adjusting cooling capacity based on the combined demands of the power application, work application, and power generator and/or power plant to improve overall system use and efficiency.

The low-emission power generation system may comprise a non-air cooling system. The non-air cooling technology may use an ASU output. The non-air cooling system may use a byproduct of the ASU process, such as liquid nitrogen or cold gaseous nitrogen, to cool a power application and/or a work application. By cooling using an ASU output, non-air cooling technology may enhance cooling performance relative to traditional cooling systems. Liquid nitrogen and cold gaseous nitrogen may achieve lower temperatures than air cooling, and manage heat from high-performance equipment. Using cold energy inherent in an ASU output may reduce the need for additional energy input for cooling and/or lower operational costs for the low-emission power generation system. The non-air cooling system may reduce the environmental impact of the low-emission power generation system by using nitrogen as cooling working fluid. Nitrogen is an inert gas that does not contribute to ozone depletion or global warming, making it an environmentally friendly coolant.

The low-emission power generation system may comprise an air cooling system. The air cooling system may cool a component of the low-emission power generation system using air at ambient temperature or at a temperature lower than the component of the low-emission power generation system.

The low-emission power generation system may use nitrogen from an ASU for power application and/or work application cooling. The use of nitrogen from an ASU for power application and/or work application cooling may use nitrogen gas generated during the air separation process to directly and/or indirectly cool at least a portion of a power application and/or a work application. Nitrogen comprises a high cooling capacity compared to cooled air and, especially in liquid form, may absorb significant amounts of heat. Nitrogen may be suitable for cooling high-density equipment. Being chemically inert, nitrogen poses no risk of combustion or corrosion, which may enhance operational safety of the low-emission power generation system and increase its longevity. Nitrogen cooling may also reduce the reliance on traditional refrigerants. Low temperatures from the ASU's refrigeration cycle may be used to cool a power application and/or a work application. The ASU may be in communication with any component of the low-emission power generation system to provide cool working fluid, e.g., liquid nitrogen or oxygen. The ASU may reduce the need for separate cooling systems, thereby lowering capital and operational expenses. The low temperatures of liquid nitrogen may be rapid and efficient heat absorption compared to other cooling fluid such as cooled air (i.e., the nitrogen may cryogenically cool a component of the low-emission power generation system). The low-emission power generation system may comprise a closed-loop system for transporting, circulating, and/or recirculating nitrogen throughout the low-emission power generation system. The low-emission power generation system may comprise a heat exchanger configured to operate at a cryogenic temperature, allowing efficient thermal transfer while maintaining structural integrity. The ASU may be configured to be retrofitted onto traditional power plant cooling systems.

The low-emission power generation system may comprise an absorption cooling system. The absorption cooling system may use waste heat to drive cooling processes and may be more energy efficient than a conventional electric-driven refrigeration system. The absorption cooling system may comprise an absorber and a generator. The absorber may absorb refrigerant vapor into an absorbent solution. The generator may use waste heat to boil the refrigerant out of the solution, regenerating the absorbent. The absorption cooling system may comprise an evaporator and a condenser. The evaporator may allow the refrigerant to absorb heat (providing cooling), and the condenser may release heat to the environment. The absorption cooling system may comprise a working fluid, e.g., a refrigerant. The refrigerant may be paired with an absorbent to form a refrigerant-absorbent pair. The refrigerant-absorbent pair may include, but is not limited to, water-lithium bromide (for cooling applications above 0° C.) and ammonia-water (suitable for temperatures at or below 0° C.).

The low-emission power generation system may comprise a refrigeration system. The refrigeration system may comprise an absorption refrigeration apparatus, adsorption refrigeration apparatus, or thermoacoustic refrigeration system, or a combination thereof. The absorption refrigeration system comprises a refrigerant-absorbent pair and uses waste heat to facilitate cooling without mechanical compressors. Adsorption refrigeration comprises a solid adsorbent material (e.g., silica gel, activated carbon) that adsorbs and desorbs refrigerant vapor when heated and cooled. The thermoacoustic refrigeration system uses acoustic waves generated by waste heat to induce a refrigeration effect without moving parts or refrigerants.

The low-emission power generation system may comprise a water-to-air heat pump. The water-to-air heat pump may drive forced air cooling on a power application and/or a work application or other component of the low-emission power generation system, such data center server racks, and may allow compatibility with components that must be air-cooled.

The low-emission power generation system may comprise a ground source cooling loop. The ground source cooling loop may comprise an underground system comprising a working fluid; a vessel to carry the working fluid; and a sink heat from a refrigeration process and may reject heat into the ground. The low-emission power generation system may comprise an open-loop cooling system. The open-loop cooling system may comprise a working fluid; a vessel to carry the working fluid; and sink heat from a refrigeration process and may reject heat into a body of water, such as a cooling pond or an underground aquifer. The low-emission power generation system may comprise a heat rejection enhancement system. The heat rejection enhancement system may be an underground system to enhance heat rejection.

The low-emission power generation system may comprise a system to transfer heat. The heat may transferred beneath the surface of the earth and/or into the earth, or into an artificial cavity. The system to transfer heat may be and/or comprise a heat sink. The system to transfer heat may permanently and/or temporarily transfer heat beneath the surface of the earth and/or into the earth, or into an artificial cavity. The system to transfer heat may transfer heat in any direction including, but not limited to, vertically, horizontally, or a combination thereof. The system to transfer heat may transfer heat below, above, and/or adjacent to the low-emission power generation system.

The heat sink may include, but is not limited to, aquifers, a subterranean pore space, a sub-surface reservoir, a sub-surface cavern, other sub-surface void, or a combination thereof. The system to transfer heat may comprise a working fluid including, but not limited to, water, an aqueous solution, a saline solution, CO₂, air, nitrogen, argon, or a combination thereof. The working fluid may be in a gaseous, solid, liquid, and/or supercritical state. The system to transfer heat may transfer heat via a conduit at least partially disposed into the earth and/or an artificial cavity.

The shared cooling system of the low-emission power generation system may reduce water consumption and is also compatible with both air and liquid cooling working fluids.

The low-emission power generation system may comprise an energy management system (“EMS”) for an integrated cycle. EMS for integrated cycles is a platform designed to optimize the operation of power plants using cycles such subcritical CO₂ and integrated HRSGs. The EMS may balance energy production, distribution, and consumption while ensuring grid stability and efficiency.

The EMS may comprise software and/or hardware configured to perform real-time monitoring; predictive analytics; load balancing; integration of renewable energy; and demand response management. Real-time monitoring may comprise continuous tracking of power generation metrics, grid demand, and operational parameters of integrated cycles. Predictive analytics may comprise using machine learning algorithms to forecast energy demand and adjust generation schedules accordingly. Load balancing may comprise dynamically distributing electrical loads across different low-emission power generation systems and geographic regions to prevent overloading and blackouts. Renewable integration may comprise coordinating with renewable energy sources such as wind or solar to incorporate them into the low-emission power generation system. Demand response management may comprise adjusting power generation and distribution in response to real-time pricing signals and demand fluctuations from a power grid in communication with the low-emission power generation system or from a component of the low-emission power generation system, e.g., the power application.

The low-emission power generation system may comprise a carbon capture and storage (“CCS”) optimization system. The carbon capture and storage (“CCS”) optimization system may capture CO₂ and/or to enhance the capture of CO₂ emissions from low-emission power generation system that generate waste heat. Waste heat from power generators and power applications may be used at any stage of carbon capture and storage. The CCS optimization system may comprise a chemical solvent that absorbs CO₂ from flue gases from a power generator. The solvent may regenerate by using heat to release the captured CO₂ from the solvent. The CCS optimization system may comprise an adsorbent material to capture and store CO₂. The adsorption material may be regenerated using temperature swing adsorption (“TSA”). TSA uses heat to regenerate adsorbent materials. Waste heat may provide the necessary temperature increase without consuming extra fuel.

The low-emission power generation system may comprise a point source carbon capture technology. The point source carbon capture technology may operate with heat below 100° C. The point source carbon capture technology may use low-grade heat, and may be configured to operate with a combined cycle power plants which may produce waste heat below 100° C.

The CCS optimization system may comprise a membrane to capture and store CO₂. The membrane may operate more efficiently at elevated temperatures, which may be supplied by waste heat. The membrane may separate CO₂ from a flue gas by allowing CO₂ to selectively pass through a permeable membrane. The membrane may comprise a material that is selective for CO₂ even at lower temperatures, e.g., below 100° C. The membrane may operate at ambient temperature and/or moderate temperatures, e.g., about 20° C. to about 100° C. Operating at ambient temperature and/or moderate temperatures may allow the membrane to maintain an optimal gas flow rate through the membrane and/or condition the gas stream. The membrane may comprise a substrate, a polymer, a metal ion, a metal-organic framework (“MOF”), or a combination thereof.

The CCS optimization system may comprise a solid sorbent. The solid sorbents may comprise an MOF, a zeolite, an ion, a matrix, or a combination thereof. The solid sorbent may adsorb CO₂ from a flue gas. The solid sorbents may be regenerated at temperatures at or below about 100° C. Regenerating the solid sorbent may release CO₂ for capture, reuse, and/or storage. The solid sorbent may operate and/or be regenerated at a temperature between about 80° C. to about 100° C. The solid sorbent may be configured to be used with a combined cycle power plant. The solid sorbent may comprise a pore with adjustable pore size. The solid sorbent may comprise functionalized activated carbon and/or a zeolite selective for CO₂. The zeolite may be configured for low-temperature (e.g., below about 100° C.) regeneration.

The CCS optimization system may comprise a calcium loop. The calcium loop may allow carbonation at lower temperatures (e.g., below about 100° C.). The calcium loop may comprise calcium oxide (CaO). The CaO may captures CO₂ to form calcium carbonate (CaCO₃). CaO may regenerated from CaCO₃ by releasing CO₂. Regeneration may occur at a temperature between about 80° C. to about 100° C. Regeneration may be achieved using low-grade heat (e.g., below 100° C.) for both capture and release phases.

The CCS optimization system may comprise an adsorption-enhanced CO₂ capture (“AEC”) technology. The AEC technology may use a solid adsorbents that may adsorb CO₂ from a gas stream at a lower temperature and may require lower thermal input for regeneration compared to traditional systems. The AEC technology may use cyclic adsorption and desorption at temperatures below about 100° C. The AEC technology may regenerate the solid sorbet at temperatures of at least about 60° C., about 60° C. to about 100° C., about 65° C. to about 95° C., about 70° C. to about 90° C., about 75° C. to about 85° C., or about 100° C. for regeneration. The AEC technology may comprise functionalized silica and/or carbon materials optimized for AEC. The AEC technology may be used for low-temperature (e.g., below 100° C.) point source capture.

The CCS optimization system may comprise carbonate looping with an aqueous solution. The aqueous solution may comprise sodium or potassium carbonate to capture CO₂ to form a bicarbonate. The CO₂ may then be released by heating the solution, aided by low-grade heat (e.g., below about 100° C.). The aqueous solution may release CO₂ using heat inputs at a temperature of at least about 60° C., about 60° C. to about 80° C., about 65° C. to about 70° C., or about 80° C. Carbonate looping with an aqueous solution may comprise a sodium carbonate-bicarbonate cycles and/or an amine-based cycle.

The CCS optimization system may comprise an ammonium-based CO₂ capture systems (e.g., a chilled ammonia process). The chilled ammonia process may comprise reacting CO₂ with aqueous ammonia to form ammonium bicarbonate. Regeneration of CO₂ from ammonium carbonate may be performed at a temperature of at least about 70° C., about 70° C. to about 90° C., about 75° C. to about 85° C., or about 90° C.

The CCS optimization system may comprise an electrochemical carbon capture system. The electrochemical carbon capture system may capture CO₂ or may use electricity rather than heat. The electrochemical carbon capture system may use low-temperature (e.g., below about 100° C.) thermal inputs to optimize the ionic movement and/or solvent flows. Low-grade heat (e.g., below 100° C.) may enhance the separation process. The electrochemical carbon capture system may comprise a CO₂ separation cell. The CO₂ separation cell may comprise an ionic liquid and/or a selective membrane.

The CCS optimization system may comprise a direct aqueous carbonation technology. The direct aqueous carbonation technology may comprise using natural minerals or industrial waste, such as slag or fly ash, in an aqueous solution to react with CO₂ to produce a carbonate. The reaction efficiency may be improved by heating the reaction. The reaction may be heated to a temperature of at least about 50° C., about 50° C. to about 90° C., about 55° C. to about 85° C., about 60° C. to about 80° C., about 65° C. to about 75° C., or about 90° C. to accelerate the reaction. For example, mineral carbonation with magnesium or calcium-rich materials may be used in combination with heating below 100° C. to increase CO₂ uptake efficiency in an aqueous solution.

The CCS optimization system may comprise other processes including, but not limited to, cooling a flue gas to condense and separate CO₂, which may then be sequestered or used; a cryogenic process to capture CO₂ from an industrial sources, including hydrogen production and steel manufacturing; use of low-temperature separation of CO₂ from a flue gas; cryogenic fractionation to capture CO₂ as a high-purity liquid product; or a combination thereof. The CCS optimization system may comprise solvent-free process.

The gas separator of low-emission power generation system may separate gases for carbon capture via the CCS optimization system. The gases may include, but are not limited to, atmospheric air, flue gas, syngas, carbon dioxide, nitrogen oxides, sulfur oxides, or a combination thereof. The gas separator may separate carbon dioxide from a flue gas or any emission from a power generator. The carbon dioxide may be conveyed to the CCS optimization system.

The low-emission power generation system may comprise a power generator (e.g., an HRSG) integrated with a power application. Integration may use waste heat from the power generator for cooling and heating of the power application. For example, the HRSG may capture exhaust heat from gas turbines in a combined cycle gas turbine (“CCGT”) plant to produce steam for additional power generation or heating applications. By integrating a power generator with a power application, waste heat may be repurposed to provide absorption cooling. Absorption cooling may comprise using waste heat to power absorption chillers that generate chilled water for a power application cooling system. Waste heat may also be repurposed to support thermal management. Supporting thermal management may comprise using steam or hot water for temperature regulation within the power application, and may reduce reliance on an electrical cooling system for the power application. Waste heat may also be repurposed to enhance energy efficiency by improving the overall efficiency of both the power generator and power application by recovering and reusing waste energy.

Integrating a power application with a combined cycle power plant (“CCPP”) to capture excess heat from the power generation process and repurpose it within the power application. Integration of the power application with a CCPP may allow more effective management of the cooling demands of the power application.

The low-emission power generation system may use waste heat for power application operations including, but not limited to, cooling. A power may generate waste heat from sources including, but not limited to, a gas turbine exhaust. The waste heat may be captured and used in absorption chillers to provide cooling for the power application. Absorption chillers may use thermal energy instead of electricity to drive a cooling process. In cold environment conditions, the waste heat from the power generator may be routed directly to the power application to maintain optimal temperatures without needing an additional heating source.

Efficiency gains from co-locating a power application with a power generator may reduce power transmission losses. Co-location of a power application with a power generator may allow immediate use of produced energy and may reduce power transmission losses as well as enhance the overall energy efficiency of the power application and/or power generator. Co-location may also stabilize power quality and accommodate power applications that are sensitive to power fluctuations. Energy storage may be co-located and/or integrated with the power generator and power application. Co-located and/or integrated energy storage may store excess power during periods of power application power demand, making the energy available during peak periods. Co-located and/or integrated energy storage may also support grid stability by balancing load demands more effectively.

The co-located power application and power generator may comprise a cooling system. The cooling system may comprise a traditional refrigeration systems combined with a ground source cooling loop. The cooling system may comprise a thermosyphon cooling system. The thermosyphon cooling system may use natural convection to move heat without a pump or compressor. Captured waste heat from the power generator may power the convection cycle. The cooling system may comprise a CO₂ and/or ammonia absorption cooling system. Using a CO₂ and/or ammonia absorption cooling system may allow for high thermal efficiency in transferring heat away from the power application. A CO₂-based system may repurpose the CO₂ emission captured from the power generator.

The co-located power application and power generator may comprise a combined heat and power (“CHP”) system. Traditional CHP systems recover waste heat for other applications, such as heating. With a power application, the heat may be used to power additional cooling processes to create a closed-loop system wherein both heating and cooling demands are managed through the CHP. The co-located power application and power generator may comprise a hybrid cooling and heating cycle. The hybrid cooling and heating cycle may allow the co-located power application and power generator to switch between using waste heat for cooling during summer and direct heating in the winter. This approach increases the year-round efficiency of both the co-located power application and power generator.

The co-located power application and power generator may use the power application's cooling load as a power demand response tool. Power application may use variable cooling loads as a demand response mechanism. During periods of high electricity demand, the power generator may prioritize energy output to the grid, while the power application may reduce cooling loads and/or shift non-critical workloads to off-peak hours. The co-located power application and power generator may be used and/or integrated with a heat storage system. The heat storage system may comprise a hot water tank and/or phase-change material (“PCM”) and may allow the power application to store thermal energy and release it during high demand. The heat storage system may allow the power application to align its cooling needs with the power generator's electricity generation schedule.

The co-located power application and power generator may optimize water use, water reclamation, and/or water recycling. Power generators may require water for cooling. This water, after cooling the power generator, may be reused in a cooling tower of the power application. Reusing the water may reduce water consumption and enhance the sustainability profile of the low-emission power generation system. The co-located power application and power generator may be configured to use evaporative and/or dry cooling. If water resources are limited, dry or hybrid cooling systems that combine air and water cooling may be integrated into co-located power application and power generator. Using reclaimed water from the power generator's cooling processes for the power application may further reduce freshwater needs.

The co-located power application and power generator may comprise an integrated carbon capture and sequestration system. CO₂ captured from the power generator's exhaust may be diverted to support cooling cycles in the power application. Direct CO₂ cooling and/or CO₂-based thermodynamic cycles may be used. The power application may be cooled by a carbon dioxide cooling system that may use CO₂ directly from a power generator output as a cooling fluid. Direct CO₂ cooling may allow the power generator to reduce CO₂ emissions while supporting power application's cooling needs.

The co-located power application and power generator may improve the overall efficiency of the low-emission power generation system through a waste heat to power (“WHP”) system comprising a topping cycle and/or bottoming cycle. The WHP system may convert excess heat from both the co-located power application and power generator back into electricity. The bottoming cycle may repurpose waste heat from data center cooling for electricity generation, and may create a regenerative cycle wherein the amount of expelled waste energy is reduced. The power generator may be preheated for cooling the power application. The power generated may comprise a preheated working fluid to cool the power application. Preheating the working fluid may increase cooling efficiency and reduce power generator fuel consumption.

The co-located power application and power generator may improve reliability and provide redundancy by creating an energy supply with continuous backup power. The co-located power application and power generator may allow the power application to receive a stable power supply that may quickly switch between alternative power generators if one power generator fails, thereby providing power supply redundancy. The co-located power application and power generator may improve grid resilience and peak energy shaving. During peak hours, the power generator may support both the power application and power grid demand by managing output dynamically. The power application's flexible loads may provide peak energy shaving, thereby enhancing the power grid's overall resilience.

The co-located power application and power generator may be scalable and/or modular. The co-located power application and power generator may operate as a module to allow both the power application and power generator to scale operations based on demand. Modular power generators and smaller, distributed cooling modules, in the power application may adapt to fluctuating workloads without compromising efficiency. The co-located power application and power generator may use energy and heat management analytics software. Real-time monitoring and advanced analytics software may manage waste heat flows between the co-located power application and power generator and provide data for optimizing energy use and maintaining balance across varying power demands.

The power application may be combined with any power generator. Integration may improve and/or maximize waste heat recovery, and may align cooling requirements with available heat, and enhance operational reliability across all environmental temperatures. Integrating the power application with a power generator may reduce operating costs of the power generator and/or power generator and may increase reliability of the power generator and/or power plant. Integrating the power application with a power generator may also unburden an associated power grid.

The low-emission power generation system may comprise a heat use. The heat use may comprise a Power-to-X (“P2X”) technology. The P2X technology may comprise one or more processes that convert surplus electrical energy, which may be from a renewable source, into chemical energy carriers such as hydrogen, methane, other liquid fuels, or a combination thereof. When integrated with waste heat utilization, these processes may become even more efficient and economically viable.

The P2X technology may comprise using electricity to produce hydrogen via electrolysis. Waste heat from a component of the low-emission power generation system may be used to enhance and/or power electrolysis. The electrolysis may comprise a high-temperature electrolytic cell including, but not limited to, a solid oxide electrolysis cell (“SOEC”). The hydrogen produced may be combined with captured CO₂ to create synthetic hydrocarbons through processes including, but not limited to, methanation, Fischer-Tropsch synthesis, or a combination thereof.

The heat use may comprise a desalination support process. The desalination support processes may use waste heat from power generation or an industrial process to drive a desalination systems, and may produce desalinated water from seawater, brackish water, brine, contaminated water, or a combination thereof. The desalination support process may enhance the overall efficiency of facilities by converting waste heat into a valuable resource. The desalination support process may comprise multi-effect distillation (“MED”). MED may use a plurality of evaporation and condensation stages, driven by thermal energy, to remove salts and impurities. The desalination support process may comprise Multi-Stage Flashing (“MSF”). MSF may comprise flashing heated saline water into steam in multiple stages, with each stage operating at progressively lower pressures. The desalination support process may comprise vapor compression distillation (“VCD”). VCD may comprise mechanical or thermal compression of vapor to enhance efficiency, which may be powered by waste heat. The desalination support process may comprise membrane distillation (“MD”). MD may comprise a thermally driven separation process where only vapor molecules transfer through a hydrophobic membrane.

The low-emission power generation system may comprise electricity or work generation through an organic Rankine cycle (“ORC”) system and/or a Kalina Cycle in communication with a power generator and/or a power or work application. Electricity or work generation through an ORC system and/or Kalina cycle may use waste heat from a power generator and/or a power or work application to produce electricity using an organic working fluids suitable for low-temperature heat sources. The ORC system may convert low-grade heat into power, and may enhance overall energy efficiency of the low-emission power generation system. The ORC system may comprise a working fluid including, but not limited to, an organic substance with a low boiling point, such as a hydrocarbon or refrigerant, that may vaporize at lower temperatures compared to water. The ORC system and/or a Kalina Cycle may comprise an evaporator and/or condenser to act as a heat exchanger to transfer thermal energy to vaporize the working fluid and subsequently condense it after expansion. The ORC system and/or a Kalina Cycle may comprise a turbine and/or expander to expand high-pressure vapor and drive a generator to produce electricity.

The low-emission power generation system may comprise a thermal energy storage system. The thermal energy storage system may capture and store waste heat for later use, balancing energy supply and demand, and improving overall efficiency. The thermal energy storage system may use sensible (e.g., a molten salts), latent heat storage (phase change materials), thermochemical storage, or a combination thereof. The thermal energy storage system may comprise a storage medium. The storage medium may comprise a material with high energy density, appropriate melting points, and thermal stability. Examples include molten salts, paraffin waxes, advanced composite materials, or a combination thereof. The thermal energy storage system may comprise an insulation technology. The insulation technology may comprise a storage container with insulation to minimize heat losses over extended periods. The thermal energy storage system may comprise a heat exchanger. The heat exchanger may transfer heat into and out of the storage medium without significant and/or measurable thermal losses.

The low-emission power generation system may comprise a bioenergy production system. The bioenergy production system may comprise nutrient recovery and biofuel production. Nutrient recovery and biofuel production may be performed through waste heat use comprising harnessing excess thermal energy from a power or work application or power generation to support biological systems that produce biofuels and recover valuable nutrients. Nutrients such as nitrogen and phosphorus from wastewater or organic waste streams may be recovered. Waste heat may aid in processes like struvite crystallization or enhanced biological phosphorus removal. The bioenergy production system may comprise anaerobic digestion enhancement. Anaerobic digestion enhancement may comprise using waste heat to maintain optimal temperatures in anaerobic digesters that convert organic waste into biogas (e.g., methane and carbon dioxide). Consistent temperatures may improve microbial activity and biogas yield. The bioenergy production system may comprise algae cultivation. Algae cultivation may be achieved by providing thermal energy to regulate the temperature of photobioreactors or open ponds used for algae growth. Algae may be processed into biodiesel, bioethanol, biohydrogen, or a combination thereof.

The low-emission power generation system may employ multimodal input and/or output integration. The input and/output may be a resource stream managed by the low-emission power generation system. The low-emission power generation system may simultaneously manage a plurality of resource streams including, but not limited to, electricity flow from on-site power generation to a power application and optionally back to a power grid; heat flow from a first power application and a second power application; a CO₂ stream captured from the power generator and transferred to mineralization processes, algae-based biofertilizer production, synthetic fuel synthesis, or a combination thereof; and/or a nutrient and water recycling flow. Byproducts from algae or other biochemical processes may be recirculated into local agriculture or industrial uses, closing loops further.

The low-emission power generation system may employ an industrial symbiosis model. For example, low-emission power generation system may comprise a greenhouse using waste heat and CO₂ to boost plant growth, a chemical plant using hot CO₂ streams to produce methanol, and a desalination unit powered by low-cost electricity for clean water production. Each component uses the input and/or output from another component to reduce waste and cost.

The low-emission power generation system may comprise and/or operate in combination with a dynamic computing relocation technology. The dynamic computing relocation technology may assist with power. The dynamic computing relocation technology may comprise a software, server, computer controller, and/or wireless transmitter. The dynamic computing relocation technology may be configured to provide an input to a power application and/or a work application to adjust computational workloads in real-time based on power availability, energy costs, or other operational considerations of the power application and/or a work application. The dynamic computing relocation technology may be configured to migrate a computing task to different geographic locations or component of the low-emission power generation system to optimize energy usage, reduce costs, and/or enhance performance of the location or component. The dynamic computing relocation technology may be configured to monitor energy in real-time and track energy supply, demand, and pricing across a plurality of low-emission power generation systems and components (e.g., a power application, work application, and/or power generator) of low-emission power generation systems. The dynamic computing relocation technology may be configured to distribute, schedule, and/or migrate power loads between different power and work applications. The dynamic computing relocation technology may be configured to forecast energy availability, costs, and compute demand to make informed and predictive decisions about workload placement. The dynamic computing relocation technology may comprise an artificial intelligence software and/or machine learning software.

An exemplary instance of a low-emission power generation system comprising and/or using a dynamic computing relocation technology is a university campus with adjacent greenhouse farming. A large A.I.-centric data center on a university campus powers a greenhouse on-site. Waste heat and CO₂ from the university campus A.I.-centric data center (e.g., the power generator) may be used for plant growth. Surplus electricity not needed for an A.I.-centric data center is sold to the grid, or used to run electrolysis for hydrogen production, or for operating the greenhouse. Another example of a low-emission power generation system comprising and/or using a dynamic computing relocation technology is an integrated industrial park. Here, a data center is co-located with a chemical plant. The chemical plant uses high-quality heat and/or CO₂ streams to produce methanol, effectively storing carbon. The data center benefits from discounted electricity from its integrated power plant and stable revenue from selling waste resources. A further example of a low-emission power generation system comprising and/or using a dynamic computing relocation technology is a rural development ecosystem. In a region with natural gas and good carbon capture potential, a data center co-locates with agricultural operations, algae ponds, and a small-scale synthetic fuel reactor. This synergy creates a local circular economy, fostering job creation and stable energy prices in an otherwise disadvantaged area.

The low-emission power generation system may comprise and/or operate in combination with a dynamic computing control technology. The dynamic computing control technology may comprise a software, server, computer controller, and/or wireless transmitter. The dynamic computing control technology may comprise routing software configured to continuously monitor temperature gradients, gas composition, CO₂ partial pressures, and other physical or chemical processes or parameters. The dynamic computing control technology may be configured to operate at least a portion of the low-emission power generation system by performing functions including, but not limited to, opening and/or closing valves, adjusting compressor speeds, engaging additional modules based on forecasted workloads and/or prices, or a combination thereof. The dynamic computing control technology may comprise predictive maintenance software configured to anticipate wear-and-tear on any component of the low-emission power generation system including, but not limited to, a pipe, compressor, heat exchanger, turbine, or a combination thereof. The dynamic computing control technology may be configured to schedule maintenance during low-load periods or when the financial opportunity cost is minimal. The dynamic computing control technology may comprise a market signal integration software configured to monitor, react to, and/or adjust power output based on an external indicator including, but not limited to, a carbon market, a renewable energy certificate (“REC”) market, a local utility auction, or a combination thereof. For example, when the value of carbon credits is high based on a given metric, the market signal integration software may maximize CO₂ capture and use of the low-emission power generation system. Another example, is that when electricity spot prices spike, the market signal integration software may divert more power to the grid instead of producing heat application products such as captured carbon or hydrogen.

The low-emission power generation system may comprise and/or operate in combination with a real-time optimization technology. The real-time optimization technology may comprise a software, server, computer controller, and/or wireless transmitter. The real-time optimization technology may be configured to employ predictive analytics, machine learning, and optimization algorithms to dynamically route resources. For example, if the real-time optimization technology predicts a dip in power application power load and thus less waste heat, it may shift working fluid usage to processes that need less heat or adjust downstream operations accordingly. Conversely, during peak loads, it may prioritize low-emission power generation system components that rely on high-quality heat.

The low-emission power generation system may integrate co-located power production, provide redundant reliability capacity, waste heat use, carbon management, and a flexibility layer to provide energy an industrial power user and/or an external electric grid.

The low-emission power generation system may comprise a plurality of electrically independent power trains. A first power train may be configured as a primary supply train for an industrial power user behind-the-meter. A second power train may be configured as a redundant reliability train for the industrial power user. The redundant reliability train may be operated as a productive generation resource in normal operation. The second power train may export power to the grid and/or provide a grid support service while remaining available for fast transfer to the industrial power user when needed. The second power train may replace a backup generator capacity of the industrial power user. The industrial power user may be retrofit or functionally repurposed such that an industrial power user that would otherwise be idle is converted into continuously or frequently dispatched prime mover.

A flexibility layer may integrate with a power train. The flexibility layer may comprise electrochemical energy storage; thermal energy storage; cold storage, power electronics, controllable industrial loads, hydrogen or other fuel production, associated storage and conversion equipment, or a combination thereof. The flexibility layer may be configured to buffer electrical trips and transients; provide fast grid response; and shift energy among electrical output, thermal output, and storable products; or a combination thereof.

Waste heat from prime movers, bottoming cycles, and/or the industrial power user may be captured on a temperature grade routing system and routed to one or more heat applications. Heat applications may include, but are not limited to, absorption cooling; process heat delivery; district energy export; water treatment or desalination; hydrogen production enhancement; pollutant separation; carbon capture solvent regeneration; a separation process; or a combination thereof. The low-emission power generation system may comprise an energy management controller. The energy management controller may coordinate dispatch among the power trains; the flexibility layer; thermal routing equipment; the industrial power user; and/or the grid. The energy management controller may optimize the low-emission power generation system for availability, emissions, fuel consumption, cost, grid services, or a combination thereof based on real-time conditions.

Cooling, process heat, and thermal integration concepts described herein apply broadly to industrial power users and industrial processes that may use heat at all temperature levels.

The low-emission power generation system may be configured to convert and/or replace reliability assets (e.g., generators) that would otherwise be idle into productive prime mover capacity. Conventional industrial sites often install standby generators to satisfy reliability objectives; those assets remain idle for most operating hours and may be restricted by permitting, fuel logistics, noise, or emissions constraints.

In contrast, the low-emission power generation system may be redundant, electrically independent power trains in which at least one train operates as a productive resource in normal operation while also serving as a reliability function for the industrial power user. The low-emission power generation system may be configured as a “2N+F” architecture comprising two independent N-trains and at least one flexibility layer (F). A first N-train (N1) may be configured to supply a critical load of an industrial power user. A second N-train (N2) may be configured to be available as backup to N1 and to provide energy export and grid support services in normal operation. The flexibility layer (F) may be configured to absorb electrical and/or power transients and to provide short-duration bridging during trips or transitions.

The N2 train may be implemented by retrofitting, repowering, replacing, and/or functionally repurposing one or more installed backup generators of an industrial power user such that the resulting N2 train comprises one or more prime movers designed for frequent or continuous operation. For example, a diesel standby fleet may be replaced with natural-gas-fired reciprocating engines; gas turbines; fuel cells; hydrogen-capable turbines; heat recovery equipment; or a combination thereof. The resulting N2 train may be synchronized to the grid and may export power when not required to supply the critical load to the industrial power user. Prime movers may be installed and commissioned faster than transmission upgrades, and they may operate independently of grid congestion.

The N-trains may be modular and may comprise a plurality of power generator units per train. Modularity may improve availability by allowing maintenance and/or unit trips without loss of the N-train's ability to supply the critical load of the industrial power user. The redundant train may also be configured to provide black start capability; voltage support; spinning reserve; frequency response; other ancillary services to the grid; or a combination thereof.

The low-emission power generation system may comprise a flexibility layer (F) that may act as a multi-service buffer between the industrial power user and the grid. The flexibility layer may be configured to absorb and/or produce power rapidly; to shift energy in time; to enhance power quality; to convert energy into storable products or service; or a combination thereof.

The flexibility layer may comprise a battery energy storage system and/or inverter. The battery energy storage system and/or inverter may be configured to provide fast power response; power frequency regulation; voltage support; ride-through during transient events (e.g., sever weather events); or a combination thereof. The battery energy storage system may be sized to bridge short-duration events, such as unit trips and switching transitions, while prime movers ramp or while dispatch is re-optimized.

The flexibility layer may comprise thermal energy storage and/or cold storage configured to time-shift heat and cooling. Thermal storage may include, but is not limited to, an insulated hot water tank; steam accumulator; phase-change media; molten salt system; other thermal storage; or a combination thereof. Cold storage may include, but is not limited to, chilled water tanks; ice storage; phase-change cold storage; or a combination thereof. The thermal energy storage and cold storage may reduce peak parasitic loads and/or enable the prime movers to operate at stable and efficient operating points.

The flexibility layer may comprise one or more power-to-X systems configured to convert surplus electrical energy and/or thermal energy into storable chemical energy carriers. The power-to-X system may include, but is not limited to, an electrolysis system, which may be for hydrogen production; a synthesis system, which may be for ammonia or other hydrogen carrier production; and a system for producing synthetic fuels using captured carbon dioxide. The flexibility layer may store produced hydrogen and/or other energy carriers. The hydrogen and/or other energy carrier may be stored for later use as fuel for prime movers or for sale or delivery to offsite users.

The flexibility layer may be configured to operate in a default mode in which it produces storable products and/or charges storage when the N-trains have excess capacity relative to industrial demand or grid conditions. Upon a disturbance or trip affecting one N-train, the flexibility layer may be configured to reduce and/or pause product production and/or redirect capacity to cover the critical load and maintain system stability with minimal loss of value.

The flexibility layer may comprise controllable loads and/or production equipment in communication with and/or associated with the industrial power user. A portion of an industrial process, compute workload, batch production process, or water treatment load may be scheduled, throttled, and/or relocated in response to grid conditions or internal system conditions to preserve reliability and optimize overall performance.

The low-emission power generation system may comprise a temperature grade routing system configured to capture and route thermal energy from one or more thermal sources to one or more heat applications. Thermal sources may include, but are not limited to, exhaust heat from prime movers; steam and hot water from heat recovery steam generators or other bottoming cycles; condenser heat; jacket water heat from prime movers; heat rejected from the industrial power user; or a combination thereof. The thermal source may be any component of the low-emission power generation system.

The N-train may comprise a combined cycle configuration comprising a gas turbine and heat recovery steam generator coupled to a steam turbine, or a reciprocating engine plant coupled to a heat recovery steam generator and steam cycle. The heat recovery steam generator may be configured to achieve supplementary firing. The supplemental firing may increase available steam and/or increase the temperature grade of available thermal energy. The steam cycle may be configured for extraction-condensing or backpressure operation. A portion of steam enthalpy from the steam cycle may be transferred to the temperature grade routing system for absorption cooling and/or other heat uses and/or heat applications.

The recovered waste heat may be applied to an absorption cooling system. The cooling system may provide chilled water and/or other coolant to the industrial power user. For example, where an industrial power user is a data center, absorption chillers may reduce or substantially eliminate the need for electrically driven chillers, thereby freeing electrical capacity for productive use and reducing peak demand on the grid. Absorption cooling may be used to cool process equipment, compressors, or other heat-sensitive systems.

The recovered waste heat may be applied to an industrial process including, but not limited to, drying, distillation, evaporation, desalination, district heating, greenhouse heating, thermal regeneration for carbon capture, or a combination thereof. The recovered waste heat may be cascaded by temperature grade such that higher temperature heat is first routed to higher value or higher temperature applications, and lower temperature heat is routed to lower temperature applications or is used as a heat pump source.

The temperature grade routing system may be integrated with thermal storage such that heat and/or cooling may be time-shifted. Thermal storage may buffer transients, support islanded operation, and/or reduce the need for cycling prime movers.

The low-emission power generation system may comprise an electrical interconnection with an external electric grid. In normal operation, the low-emission power generation system may supply the industrial power user behind-the-meter while exporting excess electricity to the grid. In addition to energy export, the low-emission power generation system may provide grid support services including frequency regulation; spinning reserve; non-spinning reserve; fast frequency response; reactive power and voltage support; black start capability; other ancillary services; or a combination thereof.

The energy management controller may be configured to schedule and/or dispatch the N-trains and the flexibility layer to satisfy a hierarchy of objectives. An example of the hierarchy of objective is: first to serve the critical load of the industrial power user within specified power quality and availability requirements; second, to maintain contingency reserves and ride-through capability; third, export power and provide contracted grid services; and fourth, produce and/or store energy products through the flexibility layer.

The low-emission power generation system may be configured for islanded (i.e., not in communication with the grid) operation as a microgrid. Upon detection of an abnormal grid condition, the low-emission power generation system may open an intertie breaker to island the industrial power user and/or local generation. Power quality may be maintained using local control of the N-trains and the flexibility layer. Once grid conditions permit, the low-emission power generation system may resynchronize and reconnect to the grid.

The low-emission power generation system may be configured to provide power to the grid during stress hours and/or to reduce the net electric demand of the industrial power user during those stress hours. Providing power to the grid during stress hours and/or reducing the net electric demand of the industrial power user during stress hours may be done by shifting cooling and/or other auxiliary loads onto the temperature grade routing system and/or by using storage and controllable loads.

The low-emission power generation system may be deployed in stages. One example of a staging approach includes commissioning one or more prime movers in a simple cycle or open cycle configuration to provide early power, followed by installation of heat recovery equipment, bottoming cycles, and thermal routing equipment to increase efficiency and expand heat utilization. Staged deployment may reduce time-to-power for the industrial power user while preserving a pathway to high-efficiency steady-state operation.

The carbon capture and clean fuel capabilities of the low-emission power generation system may be staged. For example, a first stage may commission a 2N+F configuration without carbon capture, while incorporating physical space, ducting corridors, electrical tie-ins, and thermal integration points for a future carbon capture system. A subsequent stage may add post-combustion carbon capture, direct air capture, fuel switching to low-carbon hydrogen, or a combination thereof. The staged carbon capture system may be an add-on system to the low-emission power generation system.

The low-emission power generation system may be operated under service arrangements that allocate performance obligations and economic responsibility among parties. Such arrangements may include, but are not limited to, a reliability service in which the system operator provides a specified availability or power quality level to the industrial power user and/or a thermal service in which the system operator provides cooling or process heat to the industrial power user. For example, a reliability service may be structured so that redundant capacity (for example, an N2 train) may be maintained at a target readiness level and is configured for rapid transfer to the industrial power user upon a grid outage or other contingency. The redundant capacity may operate as a productive prime mover resource in normal conditions, and its continuous operation can provide operating data that supports predictive maintenance.

In another example, cooling or process heat may be provided as a service by routing recovered thermal energy on the temperature grade routing system to an absorption cooling plant or process heat header. Where electric cooling would otherwise impose large parasitic loads, heat-driven cooling may free electrical capacity for additional industrial production or grid export.

The low-emission power generation system may comprise a controller. The controller may compute an auditable metric that characterizes performance of the low-emission power generation system. The auditable metric may be used for control, reporting, contractual settlement, or a combination thereof. The auditable metric may include, but is not limited to, heat recovery and use; water consumption or production; carbon intensity; grid support performance; a cost or affordability measure; or a combination thereof.

The controller may maintain a mass and energy balance across electrical and temperature grade routing systems. The controller may use the energy balance to coordinate dispatch among trains and the flexibility layer. The controller may route energy based on temperature grade and marginal value; and may time-shift cooling and other auxiliaries using thermal and/or cold storage. Time-shifting cooling and other auxiliaries may reduce peak coincidence with grid stress.

The trains may include, but are not limited to, a renewable and/or storage train, nuclear fission train, nuclear fusion train, geothermal train, fuel cell train, or other generation train.

The renewables and/or storage N-train may comprise a form renewable generation (e.g., wind and solar), associated storage, and/or power electronics. The renewables and/or storage N-train may be configured to provide an output to the industrial power user. The flexibility layer may comprise short-duration storage for fast response and long-duration storage or power-to-X for extended autonomy through renewable deficits. Controllable industrial loads may be scheduled to align with renewable availability.

The nuclear fission and/or fusion N-train may comprise one or more modular nuclear units coupled to an electric generator. The nuclear fission and/or fusion N-train may also comprise batteries and controllable load, and may provide fast balancing and enable steady operation of the low-emission power generation system. Recovered thermal energy may be used for absorption cooling, district heating, desalination, or hydrogen production.

The geothermal N-train may comprise a geothermal well bore, geothermal fluid transport system, and power block. The geothermal N-train may comprise a working fluid. The geothermal N-train may be combined with batteries and thermal storage. Geothermal heat may be directly used for process heat, absorption cooling, or as a heat sink for industrial cooling systems.

The power trains of the low-emission power generation system may be fully independent power trains, with each capable of carrying the entire load of the power application. The power application may continue operating even if one power train goes offline or one fuel supply is interrupted. A first N-train may feed power to the power application at any given time with a second N-train either running in parallel or on hot standby. The independent power trains may ensure uninterrupted power to the power application. The second N-train may feed power to the grid, exporting surplus power as a reliable resource. The flexibility layer may add a further layer of resiliency by ramping up to cover either side in an emergency or dial its output between electricity and thermal/chemical products as needed. The low-emission power generation system may achieve at least about 98%, about 98% to about 100%, about 98.5% to about 99.999%, about 99% to about 99.99%, or about 100% uptime. The low-emission power generation system may export power to the grid with at least about 96%, about 96% to about 99%, about 96.5% to about 98.5%, about 97% to about 98%, or about 99% availability. The low-emission power generation system may keep the power application running without fail and may operate as a near-firm power plant to the grid, with only minimal downtime (e.g., for maintenance or extreme events).

Each N-train may comprise a turbine and/or reciprocating-engine generator coupled with heat recovery steam generators (“HRSG”) that convert exhaust heat into additional electricity and usable thermal energy. The flexibility layer may comprise an F-train and may be a multi-service layer that may export electricity to the grid, produce other energy products (for example, hydrogen or other clean fuels), and provide chilling or heating, shifting among outputs as conditions warrant.

The low-emission power generation system may eliminate stranded diesel redundancy by financing the second N-train as reliability-as-a-service, and may convert both turbine-side and power application-side heat into cooling-as-a-service and other co-products rather than rejecting it to ambient. The first N-train (the “N1” train) may be dedicated to supporting the power application while the second N-train (the “N2” train) provides backup to the power application and supports the external grid. The flexibility layer may be the swing unit, which in its default state is producing storable products (molecules, cold storage, heat storage), but in the case of a trip on either N-train, the F-train can pause production and cover the trip with minimal value loss.

N1 train may be funded through the power application operator's long-term energy contract (a power purchase agreement or equivalent). N2 train may be funded through a reliability-as-a-service availability payment priced to the operator's avoided diesel cost, thereby redirecting an existing reliability budget into a high-utilization grid and backup asset. The temperature grade routing system may enable cooling-as-a-service and convert waste heat into chilled water and releasing electrical headroom.

The low-emission power generation system may be fuel-flexible and carbon-capture-ready. The turbines/engine of the power generators may burn traditional natural gas (CH₄) or hydrogen (H₂) or mixtures of both, aligning with emerging “hydrogen-ready” turbine standards. This ensures that the low-emission power generation system is future-proof as fuels decarbonize. Additionally, the plant accommodates pre- and post-combustion carbon capture, meaning most emissions may be eliminated from the low-emission power generation system by adding CO₂ capture systems on the exhaust (post-combustion) or using decarbonized fuel inputs (pre-combustion). Ductwork, layout, and hookups for carbon capture equipment are considered in the design from the start.

The low-emission power generation system may be deployed in stages. In a first stage the full 2N+F combined-cycle and thermal hub may be commissioned without carbon capture, but with physical, thermal, and permitting provisions that make a future capture retrofit practical. In a second stage, a carbon capture system (or transitions to verified clean hydrogen at scale) may be adding on using the pre-installed tie-ins so that the decarbonization step is additive rather than a redesign.

Integration of the flexibility layer and HRSGs means that the low-emission power generation system may ride through disturbances without shutting down. If, for example, the power application load were suddenly to drop or a grid connection fault occurred (a “trip” on one side), a conventional power plant might have to ramp down or even go offline to avoid imbalance. In the low-emission power generation system, the affected train's output may be quickly diverted. The HRSGs may absorb excess heat (producing steam for other uses or charging thermal storage), and the F-train of the flexibility layer may modulate its production (for example, switch to making hydrogen or dump heat into an auxiliary sink) to maintain power balance. Power generators may keep running at stable load even when one portion of the low-emission power generation system (power application power demand or grid export) experiences a disruption, because the flexible systems compensate for any lack of power. This fail-safe capability may preserve both uptime and equipment health and may avoid trips that could otherwise cause outages or damage.

The low-emission power generation system may be modular. Modularity may allow for faster, more resilient deployment of the low-emission power generation system. Major components of the low-emission power generation system may arrive and be installed in stages. For instance, the gas turbines or engine gensets may be commissioned first to start supplying power, and the HRSGs or other heat recovery modules may be added subsequently, or vice versa. Modularity may allow a low-emission power generation system to begin operations on simple-cycle mode and later upgrade to combined-cycle mode when the HRSG units are delivered, without reworking the core plant. Likewise, if the full complement of heat use equipment (like absorption chillers or electrolysis units) is not ready on day one, the low-emission power generation system may still function and later integrate those modules.

Modularity also allows the low-emission power generation system to be scalable. The low-emission power generation system may start at a smaller scale and incrementally grow (adding additional N trains or F trains) as the power application expands or as more grid support is needed. Turbines, HRSGs, chillers, thermal storage, electrolyzers, etc. may be combined and expanded as needed.

The low-emission power generation system may reuse thermal energy and may comprise an energy cascade system. Power applications may combine gas power generator heat with their own and use it year-round to meet their continuous cooling needs.

In a conventional power plant, a power application converts all its input electricity into heat, which is then discarded via cooling systems. For perspective, a facility drawing one gigawatt (“GW”) of power for compute will output roughly one GW of heat into its cooling infrastructure since all electricity from the facility use ends up as heat. Now consider the on-site power plant. A one GW combined-cycle plant producing one GW of electricity at roughly 66% net efficiency consumes about 1.5 GW of fuel energy; the remaining about 0.5 GW is rejected as heat. In a low-emission power generation system producing 2 GW of electricity, the power block rejects roughly 1 GW of heat. Combined with the power application's about 1 GW of heat, the low-emission power generation system has on the order of about 2 GW of usable thermal resource, before accounting for additional heat from the flexible layer (F). Rather than treating these heat streams as liabilities, the low-emission power generation system treats them as co-products.

For example, a 1 GW low-emission power generation system in a “2N+F” configuration with a data center power application will have an information technology (“IT”) load according to Equation (“Eq.”) (1):

P_{IT}=1GWₑ (1)

Normal operation electric output is 2 GWₑ (1 GWₑ to IT; 1 GWₑ to grid). Fuel input (two combined-cycle trains) is about 3GW_{fuel} (i.e., 3 GWₜₕ) (at 66% net efficiency. Power generator waste heat: ≈1 GWₜₕ. Data center heat: ≈1 GWₜₕ. Total heat available: ≈2 GWₜₕ (plus any contribution from the flexible layer, F).

The low-emission power generation system facilitates heat circularity that may close the cooling loop according to Eq. 2:

E_{cool,avoided}=E_{cool,base}−E_{cool,act} (2)

This term feeds directly into Heat Reuse Stewardship (H) through E_{heat,benefit}, and into Affordability (AFF) through V_{cool}.

The low-emission power generation system allows redundant capacity to become productive. In 2N+F configuration, the redundant N-train is a dispatchable grid asset when not required for contingency. The configuration reduces the stress-hour burden and supporting ancillary services, and it increases AFF through export margin and grid-service value.

The low-emission power generation system allows converted leftover heat to drive the production of co-products. After serving cooling, remaining heat can feed desalination, CCS regeneration, hydrogen systems, district heating, or other process uses. This increases H (through Q_{process}), W (if water is exported), and AFF (if co-products are monetized or offset public cost).

The low-emission power generation system may use waste heat (i.e., thermal energy) to drive low temperature cooling systems (e.g., an absorption chiller). Thermal energy may generate chilled water for the power application's cooling needs. The power application's own waste heat (and/or power generator heat) may be recycled to cool the low-emission power generation system. Use of waste heat to cool the low-emission power generation system may reduce or eliminate the need for an electric chiller. Heat from the power application may be captured and used to produce cooling, which then cools the power application equipment, in a largely closed loop. Absorption cooling powered by waste heat may reduce overall low-emission power generation system electricity demand and may provide a resiliency boost. Cooling may continue even if grid power is constrained, as long as heat is available.

The low-emission power generation system may be configured to perform a two-stage thermal cascade. High-grade turbine-side heat (e.g., exhaust and steam) may be first routed to the highest-value sinks, including absorption chilling and process heat. Lower-grade power application heat may then then cascade into secondary sinks (e.g., preheating, low-temperature chilling stages, or heat-pump lift), with thermal and cold storage used to buffer transients and to time-shift cooling. This cascade may increase the fraction of total heat that is usable, while reducing electric cooling demand.

If there is adjacent load for heat (such as a city heating network or industrial processes), the low-emission power generation system may export hot water or steam externally. Alternatively, the steam from the HRSG may feed a power application within or near to the low-emission power generation system.

The presence of abundant waste heat on-site makes it easier to implement carbon capture for the plant's own emissions. Post-combustion carbon capture (for the turbine exhaust) typically requires energy—notably heat—to regenerate solvents or sorbents used to scrub CO₂. In a low-emission power generation system, the needed heat may be supplied by the waste heat from either the turbines or even the power application (for example, using hot water from data center cooling to re-boil CO₂ capture solvents). This thermal synergy means capture CO₂ may be captured without having to burn extra fuel for capture energy. The flexibility layer may also be configured to run a carbon capture unit (for example, by driving a direct air capture system during periods of low power demand). Waste heat may also drive thermal desalination or water purification systems (e.g., multi-effect distillation, membrane distillation, etc.).

Waste heat may be reinvested into the power cycle itself. For instance, pre-heating combustion air or fuel, or using waste heat to raise the temperature of steam in the HRSG, may boost the efficiency of electricity generation (approaching combined-cycle performance or better). Waste heat may be re-directed to where it yields the highest value, for example, by providing extra power by feeding heat back into generation cycles.

The flexibility layer may use heat and power to produce valuable outputs. One example: using electricity and heat to drive an electrolyzer for hydrogen production (power-to-gas) and then using captured CO₂ plus heat to synthesize fuels or chemicals (power-to-liquids or other “X”). If there is a local industrial process like a chlor-alkali plant (which produces chlorine and caustic soda), the waste heat may be used for concentrating caustic or in other steps that require heat, improving overall efficiency.

The N2 train may comprise a combination of gas turbines, gas reciprocating engines, and duct-fired heat recovery steam generators, which do not need to consume energy when exhaust heat is available from the prime movers (the gas turbines and gas reciprocating engines). The N2 train component may be synchronized to the grid. Synchronization may allow the redundant train to participate in markets continuously and to provide spinning reserve rather than cold standby.

The low-emission power generation system may dispatch the N2 train as a power plant. The N2 train may export energy and/or provide an energy reserve margin. In contingency mode, the low-emission power generation system may be islanded and reconfigured. Because the N2 train is already operating and synchronized, it may carry the power application power load without the start delay and transfer complexity that characterize diesel backup.

The N2 train may increase local firm power capacity and reserve margin. In stressed power systems, the most acute reliability risks often occur in a handful of critical hours. The N2 train may provide reliability power capacity under stressed grid conditions.

The N2 train may provide a spinning reserve by construction. A spinning reserve resource may be already synchronized to the grid and can increase output within minutes. If a power application's redundancy is converted from cold standby into synchronized capacity, the low-emission power generation system reserve power product improves in both speed and certainty for the grid.

The low-emission power generation system may comprise a thermal architecture that reduces peak energy demand from power application. The low-emission power generation system may comprise an electrical routing system. Electric chillers tend to draw the most power in hot hours, which are frequently the same hours when the grid is constrained. Heat driven cooling shifts that load off the electrical routing system. In scarcity hours, the low-emission power generation system may also draw on thermal storage and modest setpoint flexibility to reduce parasitic load further.

Prime movers may be upgraded to a combined cycle turbine. The combined cycle upgrade performs three functions simultaneously. Firstly, the combined cycle turbine converts exhaust heat into additional electricity through the steam bottoming cycle. Secondly, the combined cycle turbine reduces the marginal cost of exported power by lowering fuel burn. Thirdly, the combined cycle turbine reduces carbon intensity and criteria pollutants per delivered megawatt hour.

The combined cycle turbine upgrade is also a system benefit. When a combined cycle plant displaces simple cycle dispatch elsewhere on the grid, the emissions reduction is not only local, but across the low-emission power generation system. This may allow the low-emission power generation system to reduce the emissions of a marginal megawatt on the system by increasing high efficiency capacity and reserves.

The efficiency difference between simple cycle and combined cycle is the difference between a peaker and a utility grade baseload power plant. For example, if a plant converts fuel to electricity at 40 percent net efficiency, it requires 2.5 units of fuel energy to produce one unit of electricity. At 66 percent efficiency, it requires roughly 1.5 units of fuel energy for the same output. That is approximately 65 percent more fuel per megawatt hour in the simple cycle case, and, absent capture, approximately 65 percent more CO₂ emissions per megawatt hour.

The upgrade also supports the thermal temperature grade routing system. Steam and hot water from the HRSG are efficiency inputs that provide high-grade thermal energy for absorption chilling and other thermal products. With a HRSG, the low-emission power generation system may route heat between power production and cooling production depending on which is more valuable in that hour.

The low-emission power generation system may operate as a thermal engine. Low-emission power generation system audits energy flows explicitly and creates a thermal balance sheet. In the 2N reference configuration, the thermal inventory is dominated by two sources: (i) heat released by the primary movers, spanning high-grade exhaust as well as lower-grade stack and condenser streams; and (ii) heat rejected by a cooled power application. The combined effect is a low-emission power generation system-scale thermal resource of low- to mid-grade heat, plus a high-grade exhaust stream that is first routed through the HRSG for power recovery.

As an example, at 66 percent net efficiency, producing two gigawatts of electricity requires roughly three gigawatts of fuel input. The remaining about one gigawatt exits as plant heat across multiple temperature bands. In parallel, the one-gigawatt power application load becomes one gigawatt of low-grade heat. An exemplary thermal cascade is show in Table 1 below.

TABLE 1
Thermal ledger and routing logic (i.e., cooling cascade): heat sources,
temperature bands, and allocation to HRSG power recovery and absorption
cooling (illustrative of 1 GW IT, 2 GW generation).

| | | | Routing and |
|---|---|---|---|
| | Thermal duty (MWₜₕ | | interaction between |
| Heat source and | per 1 GWₑ net | | HRSG power |
| stream (source → | output unless | Representative | recovery and |
| sink) | noted) | temperature (°C) | absorption cooling |
| Primary mover | Fuel input ≈ 1,515 | 450-650 °C (exhaust | Baseline: route |
| exhaust (gas | MWₜₕ per 1 GWₑ net | into HRSG) | 100% of exhaust into |
| turbine or gas | train (η = 66%); net | | the HRSG to |
| reciprocating) −> | plant heat rejection ≈ 515 | | maximize bottoming- |
| HRSG (power | MWₜₕ per train | | cycle power. If |
| recovery stream; | (stack + condenser, | | absorption chillers |
| per 1 GWₑ net train, | after HRSG power | | require higher drive |
| N1 or N2) | recovery). | | temperature, use the |
| | | | temperature |
| | | | enhancement levers |
| | | | in the row below. |
| HRSG and steam | Recovered exhaust | Steam extraction | Electricity-first; |
| cycle: recovered | heat is converted | bands: ~120-170 °C | steam extraction is a |
| exhaust heat → | into electricity in the | (LP steam or hot | controllable valve. |
| steam turbine | bottoming turbine; | water), depending on | Truncating low- |
| (electricity) and/or | steam extraction is a | design | pressure stages |
| steam extraction | controllable thermal | | increases available |
| (thermal) | off-take for cooling | | extraction |
| | and other products | | temperature and |
| | (site-specific MWₜₕ). | | MWₜₕ at the cost of |
| | | | MWₑ. Delay final |
| | | | condensation until |
| | | | thermal off-takes are |
| | | | served. |
| Post-HRSG | ≈515 MWth per 1 | Stack/hot-water: | Route plant-side |
| residual heat (stack | GWₑ net train (≈1.0 | 90-140 °C | heat to the |
| gas + | GWₜₕ across | Condenser/return: | temperature grade |
| condenser/cooling | N1 + N2), split across | 30-60 °C | routing system |
| water) → | temperature grades: | (25-40 °C in a | before any final |
| temperature grade | a hot slice | conventional | rejection. Use the |
| routing system (per | (stack/economizer | condensing cycle; | hottest slice for |
| 1 GW train) | hot water) and a low- | higher if | absorption; use low- |
| | grade slice | backpressure or | grade slices as heat- |
| | (condenser/return). | elevated condensing | pump sources or |
| | | setpoints are | reject only after |
| | | selected) | practical thermal off- |
| | | | takes are served. |
| Data hall rejected | ≈1,000 MWₜₕ (1 GWₑ | Warm-water loop: ~45- | This stream is the |
| heat (liquid-cooled | IT electricity → ≈1 | 75 °C today | cooling load served |
| loop; 1 GWₜₕ IT) → | GWₜₕ heat) plus | (>80 °C becomes | by the cooling plant. |
| temperature grade | additional balance- | increasingly | Where outlet |
| routing system | of-plant heat | plausible as rack | temperature is high |
| | depending on PUE | densities rise; 128 | enough, it can be |
| | and climate. | kW racks are | directly reused |
| | | shipping today and | (district heat, |
| | | MW-class racks are | process preheat) or |
| | | plausible within ~3 | used to drive a |
| | | years) | single-effect stage; |
| | | | otherwise, it is |
| | | | cooled via absorption |
| | | | and rejected at low |
| | | | temperature. |
| Absorption chillers: | Drive heat Q_{g} ≈ | Drive (single-effect): | Dispatch heat by |
| plant-side drive | 0.9-1.2 GWₜₕ (from | 80-95 °C | grade; temperature, |
| heat → chilled | HRSG hot water | Drive (double-effect): | not quantity, is |
| water; IT heat → | and/or extraction | 140-170 °C | typically limiting. |
| evaporator load; | steam) to deliver | Chilled water: | HRSG first for |
| reject heat → heat | cooling duty | 10-20 °C | power; then allocate |
| rejection loop | Q_{c} ≈ 1.1-1.5 GWₜₕ | Reject loop | steam/hot water to |
| | (covers 1 GWₜₕ IT | (water/air): 30-45 °C | absorption. Integrate |
| | plus auxiliaries), | | the reject loop with |
| | displacing ≈350-500 | | wet-dry heat |
| | MWₑ of electric | | rejection and thermal |
| | cooling plant load. | | storage to manage |
| | Resulting reject heat | | diurnal peaks and |
| | Qᵣₑⱼ ≈ (Q_{g} + Q_{c}) ≈ | | permitting |
| | 2.0-2.7 GWₜₕ. | | constraints. |
| Temperature | Site-specific; the | Target bands: 80- | Three pathways: (1) |
| enhancement | binding constraint is | 95 °C (single-effect); | duct firing into the |
| levers (when heat | often temperature | 140-170 °C (double- | HRSG exhaust; (2) |
| quantity is ample | rather than quantity. | effect) | diverting a fraction of |
| but temperature is | Central case thermal | | the simple-cycle |
| short) | inventory is ≈1.0 | | exhaust gas |
| | GWₜₕ of plant-side | | upstream of the final |
| | heat (N1 + N2 at 66% | | HRSG sections; and |
| | net) plus ≈1.0 GWₜₕ | | (3) steam-cycle |
| | of IT heat (1 GWₜₕ | | extraction, including |
| | IT). | | elimination of one or |
| | | | more final steam- |
| | | | turbine stages. Use |
| | | | only when the value |
| | | | of released electrical |
| | | | capacity exceeds the |
| | | | incremental fuel burn |
| | | | or foregone MWh. |
| Residual heat after | In the central case, | Central: ~35 °C | This is the remaining |
| serving HRSG | the endpoint of the | (primary residual) | thermal inventory |
| power recovery and | cascade is low-grade | Range: ~30-40 °C | after CaaS; its |
| Cooling-as-a- | reject heat of ≈2.2 | (~90-120 °C if a | exergy is low. At |
| Service (ultimate | GWₜₕ at ~35 °C | stack residual | 35 °C, 2.2 GWₜₕ |
| rejection or ultra- | (cooling-water/air | remains) | contains only ~70 |
| low temperature | loop). A reasonable | | MWₑₓ of theoretical |
| uses) | operating range is ≈2.0- | | work potential |
| | 2.6 GWₜₕ | | (T₀ = 25 °C). Further |
| | at ~30-40 °C, plus any | | monetization |
| | residual stack stream | | typically requires |
| | not captured | | upstream |
| | (~90-120 °C). | | interception at higher |
| | | | temperature (steam |
| | | | extraction) or heat |
| | | | pumps; otherwise |
| | | | reject through wet- |
| | | | dry heat rejection |
| | | | sized for climate and |
| | | | water constraints. |

A useful thermal strategy distinguishes between quantity and quality. A gigawatt of low temperature heat is not equivalent to a gigawatt of high temperature heat. The relevant concept is exergy: the maximum useful work obtainable as a heat stream equilibrates with the environment. This ladder explains the routing logic in Table 1: high-exergy exhaust should make electricity first; the remaining low-exergy heat should displace the electricity that would otherwise be consumed by cooling and other low-grade duties. Order of magnitude, 1.0 GWₜₕ of 90° C.-140° C. plant-side heat represents on the order of ~200 MWₑₓ, while 1.0 GWₜₕ of 45° C.-75° C. data-hall warm-water heat represents on the order of ~100 MWₑₓ; the 2 GWₜₕ thermal ledger is therefore a few hundred MWₑₓ, not a second power plant. In exergy terms, displacing a ~350-500 MW electric cooling block with absorption cooling shifts the exergy burden from ~350-500 MWₑₓ of electricity to roughly ~200-350 MWₑₓ of thermal exergy (plus ~10-20 MW of pumps), while consolidating the campus heat ledger into a managed reject stream at ~30-40° C.

The low-emission power generation system may use a thermal cascade managed by the thermal grade routing system. The thermal cascade may be a cooling cascade such that the thermal cascade is used to produce cooling. High temperature exhaust may drive the HRSG and produce steam. Steam first drives the bottoming turbine for additional electricity; when cooling value dominates, controlled extraction (or purposeful truncation of the lowest-pressure stages) supplies about 140° C. to about 170° C. steam or hot water to double-effect absorption chillers. The condenser may be treated as the final step in the cascade, not the first. The low-emission power generation system avoids cooling a stream to environmental discharge temperature before evaluating whether that same enthalpy can serve absorption, storage, or other thermal products. Downstream, streams that a conventional plant would reject as stack and condenser heat, are routed onto the temperature grade routing system; only after those stages does the campus reject heat to ambient. Finally, the power application heat, which may be delivered as warm water, may be either used directly where temperature is sufficient or blended and temperature-lifted when a higher drive temperature is economical. When temperature enhancement is required, the low-emission power generation system has three practical levers: duct firing; partial diversion of primary-mover exhaust upstream of the final HRSG sections; and steam-cycle extraction, including elimination of one or more final steam-turbine stages. The endpoint of the cascade is not zero heat; it is low-grade heat at about 30° C. to 40° C. that can be rejected dry or wet or routed to ultra-low-temperature sinks (see Table 1).

Thermal storage converts the thermal cascade from a passive network into an actively dispatched asset. Hot water tanks, steam accumulators, and chilled water or ice storage may decouple the timing of heat supply and heat demand. Storage allows the operator to run the low-emission power generation system for electric value while meeting cooling needs without forcing inefficient cycling.

A thermal resource may support additional products that are valuable in specific geographies. In cold climates, district heating export may displace fossil heating and create stable contracted revenue. In water scarce climates, thermal energy may drive water treatment and desalination technologies, which may reduce net water consumption and, in some cases, create net positive water output.

The flexibility layer may comprise any asset that converts time into value by shifting energy or load. The flexibility layer may comprise thermal storage that may shift the largest auxiliary load, cooling, with very low cost per unit of stored energy.

The flexibility layer may also comprise a chilled water vessel and an ice storage system to store cold. The flexibility layer may also comprise a hot water vessel and steam accumulator to store heat. The flexibility layer may also comprise a phase change material to store energy at fixed temperatures that align with specific cooling setpoints.

Thermal storage may create a dispatchable buffer between turbine operation and cooling demand. In hours when power prices are low, the low-emission power generation system may overproduce cooling, charge cold storage, and run pumps efficiently. In hours when power prices are high, the low-emission power generation system may discharge cold storage, reduce pump and fan power, and export more electricity.

Thermal storage may reduce the required size of electrochemical batteries. Batteries enable seconds to minutes response times and for bridging fast power transients, but are expensive for multi-hour shifting. Thermal storage may carry a portion of the multi-hour cooling load at a fraction of the cost. In combination, batteries provide fast response, and thermal storage provides duration. This pairing is one reason that the low-emission power generation system architecture uses 2N+F rather than 2N alone.

The low-emission power generation system may comprise an absorption chiller to use heat to drive a thermochemical cycle. The low-emission power generation system may also comprise double-effect absorption machines that may achieve thermal coefficients of performance on the order of 1.1 to 1.3.

The low-emission power generation system may shift a portion of its cooling load off the electrical routing system and onto the temperature grade routing system. Electricity is then reserved for power application and product exports, while heat drives cooling. Because pumps and controls are the primary remaining electrical loads, the incremental electric demand of the cooling system may fall by an order of magnitude. Thermodynamically, absorption cooling may consolidate the power application heat and the drive heat into a controlled low-grade reject stream, which may be managed with wet and/or dry heat rejection and storage.

This substitution is especially valuable because it is aligned with the physical profile of heat supply. Turbine exhaust and steam are available when turbines run, which is often when the grid values electricity most. The low-emission power generation system may meet cooling needs with that heat, it can export more electricity during those same hours. In other words, thermal cooling converts a portion of the low-emission power generation system parasitic load into saleable capacity precisely when capacity is scarce.

The temperature grade routing system may support water treatment. Multi-effect distillation, membrane distillation, and other thermally driven processes can use low grade heat as an energy source. In water scarce regions, the ability to treat gray water, to desalinate brackish sources, or to recover water from industrial streams can allow the low-emission power generation system to reduce net water withdrawals. The temperature grade routing system may comprise a cooling system. The cooling system may comprise and be built from multiple parallel absorption machines so that maintenance and single unit failures do not jeopardize cooling continuity.

The low-emission power generation system may provide cooling if thermal supply is interrupted. Cooling if thermal supply is interrupted may be achieved with a smaller electric chiller or air-side economization capability that can cover contingencies and commissioning periods.

The low-emission power generation system may comprise a water management system which may include, but is not limited to, a hybrid wet-dry rejection system, dry cooler, a system for water reclamation or for recovering non-potable water streams, or a combination thereof. The water management system may integrate thermal water treatment such that the low-emission power generation system may recycle water that would otherwise be discharged.

The low-emission power generation system may comprise a logic controller that may enhance part of the dispatch system. The logic controller may coordinate turbine load, HRSG steam production, storage charging, and cooling setpoints. This coordination may allow the low-emission power generation system to maintain stable electrical operation while meeting cooling and/or power demands.

The low-emission power generation system may be configured for multi-mode operation. The low-emission power generation system may comprise hardware and controls to shift configuration depending on external grid conditions and internal computing needs. The low-emission power generation system may operate in normal mode, peak support mode, islanded mode, and/or maintenance mode. Each mode has a distinct dispatch objective and a distinct thermal routing profile.

In normal mode, the grid is healthy and power application power demand is within expected range. The N1 train serves the power application power load behind the meter at high efficiency, and the N2 train exports firm power to the grid. The flexibility layer provides regulation services or charges when economics favor. The temperature grade routing system drives absorption cooling and charges thermal storage.

In peak support mode, the grid is tight. Prices spike, contingency reserves are activated, and/or the operator receives a request for emergency support. The low-emission power generation system responds by maximizing export while protecting compute uptime. The flexibility layer discharges to cover auxiliary loads and to bridge transients. Cooling setpoints can be adjusted within safe bounds, leveraging thermal storage and the thermal mass of the data halls to reduce parasitic load for limited intervals.

In islanded mode, the grid fails or a local disturbance requires separation. The low-emission power generation system islands and continues operation without transfer time. Because the gas trains are already synchronized in normal operation, islanding is primarily a breaker and control action rather than a cold start event. The N2 train can be throttled to match internal loads while maintaining N+1 redundancy, and it can provide black start support to the utility if permitted.

In maintenance mode, planned outages occur. The modularity of the 2N train design allows sequential maintenance. One train may assume the power application load while the other is serviced, and individual units within a train can be rotated. This ability to maintain uptime without extreme overbuilding is one reason that a 2N architecture with productive redundancy may be economically superior to a diesel fleet that is rarely used. Examples of the normal mode, peak support mode, islanded mode, and maintenance mode are shown below in Table 2.

TABLE 2
Illustrative operating modes in a 2N + F low emission power generation
system: electrical and thermal dispatch priorities (illustrative).

| | Trigger | | | F layer and |
|---|---|---|---|---|
| Mode | condition | N1 train (IT) | N2 train (grid) | thermal routing |
| Normal mode | Grid stable; IT | Serve IT at high | Export at | Absorption |
| | load nominal | efficiency | baseload; | chillers meet |
| | | | provide reserve | cooling; storage |
| | | | margin | charges when |
| | | | | economics |
| | | | | favor. |
| Peak support | High prices; | Maintain IT; free | Export at | Batteries |
| mode | scarcity events | headroom | maximum; | discharge; |
| | | where possible | prioritize | thermal storage |
| | | | ancillary | and setpoint |
| | | | commitments | flexibility reduce |
| | | | | parasitic load. |
| Islanded mode | Grid outage; | Continue to | Throttles to | Thermal |
| | local | serve IT without | match campus | continuity |
| | disturbance | transfer time | needs; provides | maintained; |
| | | | N + 1 redundancy | optional black |
| | | | | start support. |
| Maintenance | Planned | Serve IT if N2 | Assume IT load | Storage bridges |
| mode | equipment | available; export | if N1 offline; | ramps; controls |
| | outages | reduced | export reduced | smooth |
| | | | | transitions. |

Dispatch logic refers to how the campus allocates electrical and thermal output among competing demands: the critical power application load, grid export, thermal services, and optional conversion processes. The first priority may be to serve the power application load. The second priority may be to maintain power reserves. The low-emission power generation system may hold sufficient spinning reserve and contingency margin to protect uptime and to meet market obligations. The third priority may be to monetize surplus through the highest value outlet. When power prices are high, export is prioritized. When heat demand is high, thermal services are prioritized. When both are low, the campus can store energy or convert it through power-to-X. The fourth priority may be to route heat by temperature. High grade heat serves the highest temperature uses first, then cascades to lower temperature uses, with storage smoothing timing mismatches. The fifth priority may be to use the power application product as a dispatchable resource when possible. Deferrable workloads, such as training runs and batch inference, may be shifted in time to reduce net load in scarcity hours and to increase load in low price hours.

This dispatch approach is a departure from the static load profile of a conventional data center. The dispatch approach treats power application products and cooling as controllable variables within safe bounds, and it treats the low-emission power generation system as an asset that can be optimized hour by hour.

In an example of low-emission power generation system operation, the N1 train continues to serve the power application load. The N2 train exports at maximum. The flexibility layer discharges briefly to cover auxiliary loads and to provide fast frequency response, which frees additional turbine output for export. On the temperature grade routing system, high grade exhaust heat drives absorption chillers. If thermal storage is available, chilled water is discharged to meet the peak cooling load, allowing pumps and fans to operate at lower power. If policy and contracts allow, a small portion of non-critical compute may be deferred for an hour, reducing the power application load marginally and freeing additional megawatts for export.

The low-emission power generation system may be configured to provide a black start. Black start capability is a niche service, but its strategic value can be significant. A low-emission power generation system that can island and then re-energize portions of the local grid after a disturbance can become a resilience anchor for its community. The low-emission power generation system may support black start when it includes appropriate controls, protection schemes, and contractual permissions.

The low-emission power generation system may be configured to switch power sources (e.g., fuel types). The low-emission power generation system may comprise a turbine and/or engines configured to operate with a hydrogen blend fuel and may comprise controls and materials provisions for higher blends of hydrogen.

The low-emission power generation system may be configured to be retrofitted with a carbon capture system. The low-emission power generation system may plot space, ducting corridors, electrical tie-ins, and thermal integration points for post-combustion CO₂ capture.

The HRSG and steam cycle may be configured to support dispatchable steam extraction for absorption cooling, solvent regeneration, or industrial steam. In power scarcity hours, the low-emission power generation system may bias toward power. In cooling-constrained or heat-valuable hours, the low-emission power generation system may bias toward steam extraction, including by truncating low-value turbine stages.

The flexibility layer may be configured as a multi-product interface. Batteries, inverters, thermal storage, and optional electrolysis may be added modularly. The low-emission power generation system may alternate between exporting power, providing ancillary services, producing hydrogen, and/or buffering thermal loads.

The low-emission power generation system may be modular such that IT blocks, power generation, the F trains, and/or carbon capture system can be added as add-on modules. The low-emission power generation system may comprise a renewable plant, nuclear fission plant, and/or geothermal plant, as shown in Table 3 below.

TABLE 3
High-level comparison of follow-on C⁵ Reference Plants

| | | F layer | | | |
|---|---|---|---|---|---|
| Reference | Primary | (firming/ | Thermal | Grid | Best-fit |
| Plant | energy input | flexibility) | integration | posture | siting |
| Renewables | Wind + solar | Grid-forming | Liquid | Ancillary | Strong |
| Plant | (portfolio) | inverters; | cooling heat | services; | resources; |
| | | BESS; long- | recovery; | conditional | transmission |
| | | duration | heat pumps; | firm export | access; land |
| | | storage; load | thermal | | available |
| | | shaping | storage | | |
| Nuclear | SMR | BESS; | Absorption | Firm export; | Permitting |
| Fission Plant | modules | thermal | chilling; | inertia; V | path; security |
| | (factory-built) | buffer; | district heat; | support; | perimeter; |
| | | flexible | desalination | black-start | reliable |
| | | hydrogen | | | cooling |
| | | production | | | design |
| Geothermal | Hydro- | BESS; | Direct-use | Firm export | Resource |
| Plant | thermal/EGS | thermal | heat; | | quality; |
| | | storage | geothermal | | permitting |
| | | | heat sink | | path |

The renewables plant may be a fully integrated “renewables-to-firm” architecture for a power application. The renewables plant may comprise diversified variable power generators (e.g., solar and wind), layered storage, and/or compute-aware controls to convert intermittency into dispatchable, high-reliability power.

The reference configuration follows a 2N+F pattern built from two independent firmed-renewable trains (N1 and N2) plus a flexibility layer (F). Each N-train includes: (1) a contracted or owned portfolio of wind and solar generation; (2) grid-forming power electronics; and (3) energy storage sized to deliver a continuous, quality-controlled AC power supply to the data hall. One N-train is scheduled as the primary behind-the-meter supply for the IT load; the other is scheduled as the grid-facing train that normally exports power, while standing ready as “hot” backup to the data center. The F-layer adds fast frequency response, longer-duration energy shifting, and optional power-to-molecules equipment (electrolyzers and hydrogen storage) that may absorb surplus renewable output and later reconvert it to electricity when renewables are scarce.

Unlike combustion-based plants, a renewables platform must manage uncertainty rather than fuel scarcity. The architecture therefore treats forecast error as a design input. Reliability is achieved by stacking independent protections: (a) 2N electrical redundancy; (b) multiple, electrically isolated storage strings and inverters; (c) a grid-forming microgrid control layer that can island instantly; and (d) a “scarcity playbook” that prioritizes critical IT, curtails deferrable compute, and preserves reserve margins when renewable conditions deteriorate. In steady state, batteries provide sub-second ride-through and replace the traditional UPS function; longer-duration storage preserves continuity through multi-hour and multi-day renewable shortfalls. The renewables plant's reliability posture is therefore defined by reserve energy, not by spinning inertia; the design emphasizes redundant inverters, fault isolation, and black-start capability.

The renewables plant may be modular. Generation is deployed as incremental blocks (tens to hundreds of megawatts); storage is deployed as containerized units; and inverters and switchgear scale linearly with capacity. This allows phased commissioning: the data center may begin operations with the first N-train and a baseline storage stack, then expand toward full 2N+F as the campus grows and as additional renewable interconnection is completed. Because permitting and interconnection, not equipment fabrication, is often the critical path for renewables, the reference design assumes early, parallel development of transmission access and grid studies.

A renewables-only power block does not produce high-temperature waste heat; the dominant thermal resource is the data center's own heat. The renewables plant therefore treats the data hall as a heat hub. Direct-to-chip liquid cooling enables warm-water loops that can export heat at temperatures useful for district heating and low-temperature industrial processes. Where off-takers exist, heat pumps can lift that heat to higher delivery temperatures; where they do not, the design favors dry or hybrid heat rejection to minimize water consumption. Thermal storage (hot water tanks, borehole fields, or other seasonal systems) can time-shift heat delivery and create an additional grid-smoothing lever by coupling heat pump operation to renewable surplus hours.

The renewables plant is designed to be explicitly multi-mode. In renewable surplus hours, it can export power, charge batteries, and convert electricity into hydrogen. In normal hours, it serves the IT load while maintaining reserve margins. In renewable deficit hours, it discharges storage and may reconvert stored hydrogen to electricity; at the same time, it sheds non-critical compute to preserve uptime for critical workloads. In grid-disturbance conditions, it islands within cycles and maintains voltage and frequency using grid-forming inverters and storage.

The renewables plant's economic case rests on a simple premise: a data center is among the few industrial loads that is both large enough and controllable enough to underwrite a firmed-renewables portfolio. By combining predictable baseload demand with a stacked flexibility layer, the site can monetize renewable volatility rather than be constrained by it.

The renewables plant enables near-zero operational emissions without reliance on combustion; this lowers carbon risk and can command premium offtake in “24/7 clean” procurement regimes. Storage and inverter capability allow the renewables plant to behave as a grid asset, capturing ancillary service revenues (frequency regulation, voltage support, spinning-equivalent reserve) and reducing congestion and peak demand impacts. The data center's own operational flexibility becomes monetizable: deferrable compute can be scheduled into low-price, high-renewable hours; critical compute retains five-nines reliability through dedicated reserves.

As an example of renewable plant operation, a continuous 1 GW IT load consumes 8.76 TWh per year. Let CF_{portfolio} be the net annual capacity factor of the renewable portfolio delivered to the point of interconnection, after curtailment and losses.

A first-order sizing relationship is:

Pₙₐₘₑₚₗₐₜₑ≈(P_{IT}/CF_{portfolio})×(1+overbuild margin) (3)

Storage energy for autonomy is:

E_{storage}≈P_{IT}×T_{autonomy} (4)
where T_{autonomy} is the target duration of islanded operation through renewable deficits. In practice, the portfolio is sized for both energy sufficiency (annual MWh) and scarcity adequacy (multi-day weather events); the latter typically dominates storage sizing.

TABLE 4
Illustrative configuration for a 1 GW renewables plant.

| | | Purpose in the 2N + F |
|---|---|---|
| System element | Illustrative sizing | architecture |
| N1 firmed-renewables train | Portfolio delivering ~1.2 GW | Behind-the-meter supply to |
| | firmed output; backed by | critical IT load with margin |
| | storage | |
| N2 firmed-renewables train | Portfolio delivering ~1.2 GW | Grid export under normal |
| | firmed output; backed by | operation; hot standby for N1 |
| | storage | |
| Short-duration BESS | 2-4 GW/8-16 GWh total | UPS replacement; sub- |
| | (distributed across N and F) | second balancing; |
| | | contingency ride-through |
| Long-duration storage | Hydrogen or other LDES | Multi-day renewable drought |
| | equivalent to 1-3 days of IT | coverage; seasonal shifting; |
| | load (24-72 GWh+) | firm capacity |
| Grid-forming inverters and | Sized for full campus power | Stable islanded operation; |
| controls | plus fault ride-through | voltage and frequency control |

The nuclear fission plant adapts the 2N+F architecture to a nuclear prime mover. Its distinguishing feature is firm, high-capacity-factor, zero-carbon electricity paired with a steady stream of usable thermal energy. The reference configuration assumes small modular reactors (“SMRs”) or equivalent modular nuclear units to enable redundancy, phased deployment, and maintenance without sacrificing data center uptime.

The nuclear fission plant configuration uses two physically and electrically independent nuclear islands, each comprising multiple reactor modules feeding a shared turbine-generator block and auxiliary systems. N1 is the behind-the-meter train serving the critical power application load; N2 is the grid-facing train that exports power under normal operation and stands ready to assume the power application load during N1 outages. Because nuclear units operate most efficiently at steady thermal output, the F-layer is designed to absorb short-term volatility: batteries provide instantaneous ride-through, while flexible electrical loads (notably hydrogen electrolysis) and thermal buffers absorb deviations between reactor output, power application demand, and grid schedules. This allows the reactors to remain near-constant while the delivered electrical output is shaped dynamically.

Nuclear plants are inherently capacity-grade, but they are not inherently redundant. The reference design therefore uses modularity as the reliability tool: each N-train is composed of multiple SMR modules so that the loss of one module does not jeopardize the train's ability to carry the I power application load. Planned outages (refueling or major maintenance) are managed by staggering module schedules across N1 and N2; the grid-facing train is always operated as “hot” standby for immediate failover. The F-layer batteries are sized to bridge the fastest contingencies and to maintain uninterrupted power quality to sensitive power application equipment during switching events. In effect, the plant combines nuclear's high availability with data-center-grade electrical redundancy.

The nuclear fission plant is structured for phased build-out. SMR modules may be commissioned sequentially as they are delivered and licensed; the power application may begin operations once the first tranche achieves N-level capability. Additional modules may then be added to reach 2N+F, with each increment increasing both uptime margin and grid export capacity. This phasing also matches capital deployment to data hall growth, reducing the risk of stranded generation capacity during early years of campus ramp-up.

A nuclear plant produces large quantities of low- and medium-temperature heat. Instead of rejecting that heat through large cooling towers, the low-emission power generation system configuration treats it as a co-product. Absorption chillers may convert reactor waste heat into chilled water for the data hall, reducing electric cooling loads. Where local conditions support it, the nuclear fission plant may export district heat, run desalination systems, or drive high-temperature steam electrolysis for hydrogen production.

In normal mode, N1 train serves the power application and N2 train exports firm power to the grid. When power application load dips, the plant maintains reactor output by increasing flexible loads (electrolysis, thermal storage charging) or by exporting additional power. During grid disturbances, the site islands using their own generation and storage; when conditions permit, it can also provide black-start support to nearby grid infrastructure through pre-engineered interconnection and protection schemes.

First, the nuclear fission plant supplies near-constant, zero-carbon electricity at high availability; this enables five-nines compute without a large long-duration storage stack. Second, the grid-facing N-train can sell capacity-grade power and ancillary services, improving the project's revenue diversification. Third, the steady thermal output enables economically meaningful heat reuse: cooling-as-a-service for the data hall, district heat where available, and process heat for water treatment or industrial partners. Fourth, flexible loads such as electrolysis transform what would be curtailment into monetizable molecules, while also providing a controllable sink that improves grid stability.

As an example of plant operation, let P_{Power App.} be the critical power application load. In a modular reactor configuration, the primary sizing decision is the number and rating of reactor modules per train, chosen to meet P_{Power App.} with margin under N-1 module loss. A simple redundancy relationship is:

N_{modules}×P_{module}×(1−forced outage allowance)≥P_{Power Ap.}+reserve margin (5)

The F-layer battery energy is sized for ride-through rather than for multi-day autonomy:

E_{BESS}≈P_{Power App.}×T_{bridge} (6)

where T_{bridge} is typically minutes to hours, not days. Thermal reuse capacity is sized to the data hall heat load and to off-taker demand; absorption chilling capacity scales directly with the cooling load served.

TABLE 5
Illustrative configuration for a 1 GW Nuclear Fission Plant.

| | | Purpose in the 2N + F |
|---|---|---|
| System element | Illustrative sizing | architecture |
| N1 nuclear train | Multiple SMR modules | Behind-the-meter prime |
| | totaling ~1.2 GW net | power for critical IT load |
| N2 nuclear train | Multiple SMR modules | Firm grid export; hot standby |
| | totaling ~1.2 GW net | to assume IT load |
| F-layer batteries | 100-300 MW/0.2-1.0 GWh | Ride-through; power quality; |
| | (distributed) | fast contingency response |
| Flexible electrical loads | Electrolyzers or other | Absorb output when IT load |
| | controllable loads (100 + MW) | is low; produce hydrogen; |
| | | support grid balancing |
| Thermal utilization block | Absorption chillers; district | Cooling-as-a-service; heat |
| | heat exchangers as | export; improved overall |
| | applicable | efficiency |

The geothermal plant uses geothermal energy as a continuous, dispatchable renewable source for compute. Its advantage is dual output: electricity plus direct heat services. In favorable geology, geothermal can provide near-baseload generation with low operating emissions and stable long-term energy costs.

The reference configuration pairs two independent geothermal power trains with an F-layer that adds fast response and multi-product optionality. Each N-train comprises a geothermal field (hydrothermal wells or enhanced geothermal well pairs), surface gathering systems, and a power block. Depending on resource temperature, the power block may be a flash steam turbine or a binary organic Rankine cycle (“ORC”). The N1 train is scheduled to serve the data center behind the meter; N2 exports to the grid and serves as the primary backup train. The flexibility layers comprises batteries for rapid balancing, thermal storage for heat management, and optional power-to-molecules equipment that can absorb surplus generation or provide seasonal buffers.

Geothermal reliability depends on reservoir performance and wellfield redundancy. The geothermal plant therefore uses a plurality well pairs per power train, with spare drilling capacity and surface modularity so that declining wells can be replaced without interrupting service. With a sufficiently redundant wellfield, geothermal plants may achieve high availability; the 2N architecture then elevates that to data-center-grade reliability. Batteries and power electronics provide the same role as in other reference plants: fast ride-through, power quality, and seamless islanding during grid faults.

The geothermal plant is modular at the well-pair and power-block level. Drilling may proceed in phases; each completed well pair feeds an incremental ORC or turbine block that can be commissioned as soon as it is connected. This supports staged delivery: early wells and the first power block can serve initial power application loads, while additional wells and blocks scale with campus growth. Because subsurface uncertainty is the dominant development risk, the reference strategy emphasizes early appraisal drilling and a “repeatable well pattern” that can be expanded once performance is proven.

The geothermal plant's defining advantage is heat. Even when the resource temperature is better suited to binary generation, significant low-grade heat remains available for direct use. The reference design therefore includes a heat distribution header that can serve district heating, greenhouses, industrial processes, absorption cooling, and water treatment. In many climates, geothermal heat can also be used as a stable heat sink for power application cooling, reducing evaporative water use and stabilizing cooling efficiency across seasons.

In normal mode, N1 supplies the data center and N2 exports power. During periods of low grid prices or constrained export, the plant can redirect output into thermal services, storage charging, or optional hydrogen production. During grid disturbances, the site islands and continues serving the power application using geothermal generation and batteries; the grid-facing train can support black-start and local restoration where interconnection rules allow.

Geothermal sizing begins with the deliverable net capacity per well pair and the sustainable production profile of the reservoir. If each well pair supports Pₚₐᵢᵣ megawatts net, then the number of pairs per N-train is approximately:

Nₚₐᵢᵣₛ≈(P_{Power app.}+reserve margin)/Pₚₐᵢᵣ (7)

Because geothermal is typically firm, the long-duration storage requirement is modest; batteries are sized for contingency bridging and grid services. The thermal utilization block is sized to the power application heat load and to available off-takers; in many cases, the temperature grade routing system case improves markedly when the site is co-located with a district heat network or heat-intensive industry.

TABLE 6
Illustrative configuration for a 1 GW geothermal plant.

| | | Purpose in the 2N + F |
|---|---|---|
| System element | Illustrative sizing | architecture |
| N1 geothermal train | Geothermal field + power | Behind-the-meter prime |
| | block totaling ~1.1-1.3 GW | power for critical IT load |
| | net (site-dependent) | |
| N2 geothermal train | Geothermal field + power | Grid export; redundancy and |
| | block totaling ~1.1-1.3 GW | hot standby |
| | net (site-dependent) | |
| F-layer batteries | 100-300 MW/0.2-1.0 GWh | Fast response; ride-through; |
| | (distributed) | ancillary services |
| Thermal utilization block | Heat exchangers; absorption | Cooling savings; heat sales; |
| | chillers; district heat header | water treatment integration |
| Wellfield redundancy | Spare well pads and drilling | Maintains output over time; |
| | capacity | replaces declining wells |
| | | without downtime |

Embodiments of the present invention provide a technology-based solution that overcomes existing problems with the current state of the art in a technical way to satisfy an existing problem for waste heat and energy inefficiencies generated by power plants and/or power applications. Embodiments of the present invention achieve important benefits over the current state of the art, such as increased power generation or power application efficiency; decreased cost and improved heat use relative to comparable technologies; and heat application product production. Some of the unconventional steps of embodiments of the present invention include the use of heat generated by power plants and/or power applications by integrating a power source, power plant, and/or power application with one another, wherein the heat is used to increase efficiency or generate a product.

Note that in the specification and claims, “about” or “approximately” means within twenty percent (20%) of the numerical amount cited. The terms, “a”, “an”, “the”, and “said” mean “one or more” unless context explicitly dictates otherwise.

Although the invention has been described in detail with particular reference to these embodiments, other embodiments achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A low-emission power generation system, said system comprising:
a power source in communication with a power generator;
said power generator in communication with a power application and a power grid; and
a heat application in communication with said power generator or said power application.

2. The system of claim 1 further comprising a thermosiphon in communication with said power generator.

3. The system of claim 1 further comprising a gas separator in communication with said power generator.

4. The system of claim 1 further comprising a dynamic energy routing system.

5. The system of claim 1 further comprising a waste heat recovery system.

6. The system of claim 1 configured to receive a carbon capture system as an add-on system.

7. The system of claim 1 further comprising a cooling cascade system.

8. A method of low-emission power generation, the method comprising:
transferring power from a power source to a power generator;
generating power;
transferring power to a power grid and a power application;
forming a power application product;
generating heat from the power generator; and
transferring the heat from the power generator to a heat application.

9. The method of claim 8 wherein the power source comprises natural gas.

10. The method of claim 8 wherein the power generator comprises a steam turbine configured for duct firing.

11. The method of claim 8 further comprising generating heat from the power application.

12. The method of claim 11 further comprising transferring the heat from the power application to the heat application.

13. The method of claim 8 further comprising producing a heat application product from the heat application.

14. The method of claim 8 further comprising cooling the power generator.

15. A low-emission power generation system, said system comprising:
a first power train in communication with a power source and a first power application;
a second power train in communication with said power source and said first power train;
a temperature grade routing system; and
a flexibility layer in communication with said first power train.

16. The system of claim 15 wherein said flexibility layer comprises a third power train.

17. The system of claim 15 further comprising said flexibility layer in communication with a second power application.

18. The system of claim 15 further comprising said second power application in communication with a power grid.

19. The system of claim 15 further comprising said flexibility layer in communication with said power source.

20. The system of claim 15 further comprising said flexibility layer in communication with said second power train.
